(19) United States
(12) Patent Application Publication
(10) Pub. No.: US 2005/0246215 A1
(43) Pub. Date: Nov. 3, 2005

(54) System and method for alignment of an enterprise to a component business model

(76) Inventor: Guy Jonathan James Rackham, New York, NY (US)

Correspondence Address: Whitham, Curtis, & Christofferson, P.C., Suite 340, 11491 Sunset Hills Road, Reston, VA, 20190, US

(21) Appl. No.: 11/176,371

(22) Filed: Jul. 8, 2005

Related U.S. Application Data
(63) Continuation-in-part of application No. 10/796,367, filed on Mar. 9, 2004.

(51) Int. Cl. G06F 17/60

(52) U.S. Cl. 705/7

(57) ABSTRACT

A system and method for representing a business with a component map of a target state of the business, arraying the components by competency and by management level, where each component is a group of cohesive business activities within a competency, and each competency is a non-overlapping partition of the activities of the business. An enterprise component map is also built, representing all businesses and serving as a basis for industry component maps and business component maps. The enterprise component map is partitioned into non-overlapping managing concepts, where each competency is formed of one or more managing concepts. Overlays of the current state of the business upon the component map are used to determine differences between the component map and the current state of the business, and these differences are prioritized for alignment of the business to high priority components of the component map.

This invention is a continuation in part of co-pending application Ser. No. 10/796,367 entitled “Services Component Business Operation Method” to the same inventor, which application is incorporated herein by reference.

### BACKGROUND OF THE INVENTION

1. Field of the Invention

The present invention generally relates to component based business models and, more particularly, to techniques for describing business components and their connection to other business components and for aligning an enterprise to a model of such components.

2. Background Description

As business enterprises develop, time and resource constraints frequently operate to limit adaptations—adaptations required by changing business conditions and opportunities—to resolution of problems defined narrowly in scope and time. The result of a succession of adaptations of this kind is an increase in complexity of the enterprise and a movement away from an optimal business model. This result becomes particularly acute for very large enterprises, all the more so in today's on-demand business environment, where a premium is placed on the ability of a business to exhibit On-Demand characteristics: being able to cope with volatility in demand; being responsive and flexible in the face of market change; being well equipped, highly leveraged and fully utilized; and being resilient, regardless of external events.

Existing approaches to business modeling represent an organization in terms of a specific dimension and/or property (e.g. its systems, organization structure, or geographic footprint) or in terms of particular themes and key processes (e.g. risk exposure, capital deployed, new product development and deployment). But these approaches do not attempt to analyze the interdependencies between differing aspects (such as people/process/technology) in a common perspective. A common perspective exposes the synergies between these differing aspects of the business.

Further, the structure of an organization, its boundaries and natural fault lines are hidden when a limited or specialized perspective is used. Existing approaches often attempt to model a business entity as a monolithic whole rather than as a collection of discrete specialized and unique ‘ingredients’ or components that may express radically different properties individually. Many existing analytical approaches are predicated on a theoretically optimized process model—such as “6 Sigma” or “Total Quality Management” (TQM)—that is analyzed by considering individual processes in isolation.

What is needed is an approach to business modeling that overcomes the above described problems of limited focus.

### SUMMARY OF THE INVENTION

It is therefore an object of the invention to provide a model for the business that can serve as a foundation for comprehensively displaying the activities, systems, applications, roles and business rules of the business.

Consequently, an object of this invention is to provide a methodology for building a component business model of an enterprise, and providing representational tools enabling identification of steps to transform the enterprise to that model.

Another object of the invention is to provide a method to partition an organization into discrete specialist components, to support a service enabled collaborative operating model.

An object of the invention is also to use a component business model to evaluate current operations of an enterprise against a target operating paradigm and isolate points of constraint and/or transformational opportunities to change the existing operational capability.

A further object of the invention is to provide a method to isolate discrete component boundaries coincident with considerations including functional specialization and purpose, organizational role (including skill and authority), as well as operational and technical needs and aspirations.

It is also an object of the invention to provide a method to associate the role of each component with one of a finite set of possible generic specializations as defined in an enterprise/universal model of all possible business components and their viable configurations.

Another object of the invention is to develop a component model where each component specialization represents an associated competency to effect and influence organizational behavior based on a design, concept or policy created to enable cooperative operation.

A further object of the invention is to develop a component model where each component's role may be supported and/or exploited through an agreed format of interaction between two or more components in multiple asynchronous and additive invocations of the components' business services.

Yet another object of the invention is to provide a model where the role of a generic component recorded in the enterprise model may be specialized in a specific implementation, refining and extending its properties to encompass specific needs based on practical consideration including (but not limited to) scale, geography, industry sector and maturity.

It is also an object of the invention to provide a model so that the physical realization of a component (existing and/or target) may be mapped to a single physical instance, multiple similar instances and/or multiple unique instances that expose some degree of consistency in their role, boundaries and service interactions with other components.

It is another object of the invention to provide a model wherein the role of a component may be further typified in terms of the competency it supports in that it provides ‘direction services’ (planning, budgeting, organization definition, policy, performance assessment) , ‘control services’ (task and resource allocation, authorization and/or specific decision making, oversight and troubleshooting) or ‘execution services’ (support in the fulfillment of its role).

Another object of the invention is to provide a model wherein the role of a component may be further categorized as transactional (i.e. it is invoked in the execution of a business transaction—fulfilling the purpose of the organization) and/or support (i.e. its role is to establish and maintain the capacity to execute transactions on behalf of one or more transactional components.

The component business model reflects a view of the enterprise from the perspective of non-overlapping clusters of activities, arrayed by activity group and level of management. The model may be compared to the actual state of the enterprise, and this comparison provides a basis for creating a roadmap for improving alignment of the enterprise with the model. The methodology of the invention includes a filtering step which identifies those components whose alignment with the component business model is most likely to improve the operability of the enterprise, within the limited time and resources made available for application of the methodology.

The invention seeks to solve the problem of limited focus both in terms of the narrow process perspective and the topic of analysis by defining a partitioning of an enterprise that exposes its unique, non-overlapping, specialized components in a manner where they can be considered individually in terms of the role they perform for the ‘collective’ and in various combinations in the execution of business.

After completion of the invention's methodology on a filtered subset of the enterprise's components, however, there will be continuing pressures to adapt the enterprise to changing business circumstances and opportunities. Because of time and resource constraints upon these subsequent adaptations, some and perhaps many of them will provide solutions that degrade rather than enhance alignment with an optimized component business model of the enterprise. Thus, at a later time a further effort to improve alignment to a component business model may be advantageous to the enterprise.

Consequently, a further object of this invention is to provide a methodology that can be applied periodically or continually, as time and resources become available to the enterprise, addressed to those components that can be aligned within the available time and resources and whose alignment is most likely to improve the operability of the enterprise.

While it is possible in principle for an enterprise to allocate sufficient resources to deal with adaptations required by changing business conditions, the time constraints applied by the market place may nonetheless frustrate intentions to maintain alignment to a component business model, leading to a consequent increase in complexity and a departure from an efficient component business model. The present invention provides a methodology which can be applied periodically so as to optimally use available time and resources for improving alignment of the enterprise with a component business model. For the purposes of this disclosure, this will be referred to as “piecewise alignment.” Thus the present invention provides a system and method for piecewise alignment of an enterprise with a component business model. The selection of components for a “piecewise alignment” may be driven by a variety of factors, including business performance considerations, efficiency, competitive priorities, opportunity windows, appetite for risk or change, and other constraints. It should be noted that the definition of a target component and the evaluation of a business organization against that target component may change as a result of alignment efforts and developments in the marketplace.

The present invention is more narrowly focused than the concept of building a business using components from different sources. The general concept of component based business models has been in use for a number of years. Such models have been applied to analyze an operating enterprise and, for example, to construct a business from components supplied from a variety of sources. However, the prior art lacks a methodology and set of metrics for construction of a target component business model for an enterprise and for development and execution of steps better aligning the enterprise with its target component business model. The present invention can be used to enhance an enterprise's ability to make so-called “outsourcing” arrangements for a subset of its business components, thereby enabling the enterprise to focus attention on other components that provide better leverage for achieving the goals of the enterprise. But methodologies and strategies for making and integrating such outsourcing arrangements are outside the scope of this invention.

Prior component approaches have been limited to considering particular aspects of a business need, such as technology components when assembling a business system. CBM constructs partitions along boundaries that represent sensible cleavage points, thereby carving a business into discrete specialist capabilities. These partitions take into account process, technology and organization in combination, thereby identifying practical building blocks that can be consistently applied within and across industries. The methodology begins with the assumption that everything is on the table, and that the whole that is on the table is being partitioned into practical building blocks. The process is analogous to partitioning a geographic area into zip codes, but is more complex because the basis for partitioning is not a simple two dimensional space but a combination of practical aspects of commercial enterprise (i.e. process, technology and organization) that are not orthogonal. The work product of this partitioning methodology is maintained in a repository, which grows in an iterative manner. Other component approaches in the prior art do not take a comprehensive and iterative partitioning approach, but are limited to specifying re-usable elements of custom solutions within each organization.

The partitioning methodology of the invention begins with what is termed a “managing concept”. This term is specially defined for the purpose of describing the invention, and is not literally a “managing concept” as that phrase would be understood in the art. For describing this invention, “managing concept” is the term associated with the following aspects of the partitioning methodology. First, the methodology is a partitioning methodology, as described above. Although difficult to accomplish in practice—and thus requiring an iterative approach—the concept is to begin with a whole and partition the whole into necessarily non-overlapping parts. Second, experience has shown that the partitioning process works best when addressed to an asset of the business. The asset can be further described by attributes. Third, the building block must include mechanisms for doing something commercially useful with the asset. For a sensibly defined managing concept these mechanisms must cover the full range of management accountability levels (i.e. direct, control and execute). Further partitioning of managing concepts into components usually falls along boundaries between these management accountability levels. It is important to emphasize that the boundaries between managing concepts (and between components within managing concepts) are logical rather than physical. This is particularly important when applying the invention to small enterprises having fewer physical assets, where it is more likely that logical partitions and physical units may not track one another. But it is also important when applying the invention to medium and large scale organizations, in order to overcome the above discussed prior art deficiencies.

The CBM model of a business can be used to represent a target state where many attributions can be applied to reflect perspectives including: some comparative measure of performance (including benchmarks, performance indicators and measures); some aspect of its design (including the skills, authority and organization of users associated with it execution), the functional and service architecture of its operation, and the technical and operational properties and characteristics of its supporting business systems (including but not limited to those aspects supported by information technology); some measure of existing capabilities and an evaluation of the impact of associated shortfalls to goal; and some representation of task planned and/or underway to evolve the capability of a component and associated justification for change.

### BRIEF DESCRIPTION OF THE DRAWINGS

The foregoing and other objects, aspects and advantages will be better understood from the following detailed description of a preferred embodiment of the invention with reference to the drawings, in which:

FIGS. 1A through 1D show the structure of a repository of business components and their attributes. FIG. 1A is table showing a universal enterprise map of business components. FIG. 1B highlights the major categories of managing concept columns shown in FIG. 1A. FIG. 1C describes one of the managing concept columns shown in FIG. 1A. FIG. 1D shows detail contained in the repository for the managing concept shown in FIG. 1C.

FIG. 2A shows the derivation of an industry map of competencies from the universal map shown in FIG. 1A. FIG. 2B details the structure of an industry map.

FIG. 3A is a schematic representation of a business component. FIG. 3B shows a collaboration of components overlaid upon a map of business components.

FIGS. 4A through 4E are diagrams illustrating transitions to improved component collaboration configurations: consolidator components (4A); gatekeeper components (4B); processor components (4C); controller components (4D); and analyzer components (4E).

FIG. 5 is an overlay upon a target component map for the purpose of showing gaps, overextensions and duplications in current systems.

FIG. 6A is a diagram showing a CBM CBM stack. FIG. 6B is a diagram and schematic showing detail and context for the CBM stack. FIG. 6C is a schematic showing CBM definition of key features of the CBM stack.

FIG. 7A is diagram showing a screen display structure for navigating through the information stored in the repository of the component business model. FIG. 7B is an exemplar component business map. FIG. 7C shows an implementation of the structure shown in FIG. 7A, with the component business map of FIG. 7B as the central display element. FIG. 7D shows a “grid shift” re-display of the display element of FIG. 7C. FIG. 7E is a “clock face” display associated with the highlighted component in the component map shown in FIG. 7C. FIG. 7F shows a “grid shift” re-display of the “clock face” display shown in FIG. 7E.

FIG. 8A shows an overlay upon a component business map of a wiring diagram connecting components in a process. FIG. 8B is a schematic showing a mapping between a static component map and a dynamic component map. FIG. 8C is a diagram showing an overlay of components from a static component map upon a dynamic component map. FIG. 8D is a conceptual diagram of a connection between categories on a dynamic component map. FIG. 8E is an overlay upon a dynamic component map of a wiring diagram of the same process connected in FIG. 8A.

FIG. 9A is a comparative schematic representing the difference between planned and actual development of business adaptations. FIG. 9B is a schematic showing how the representation of business processes are simplified by using components.

### DETAILED DESCRIPTION OF A PREFERRED EMBODIMENT OF THE INVENTION

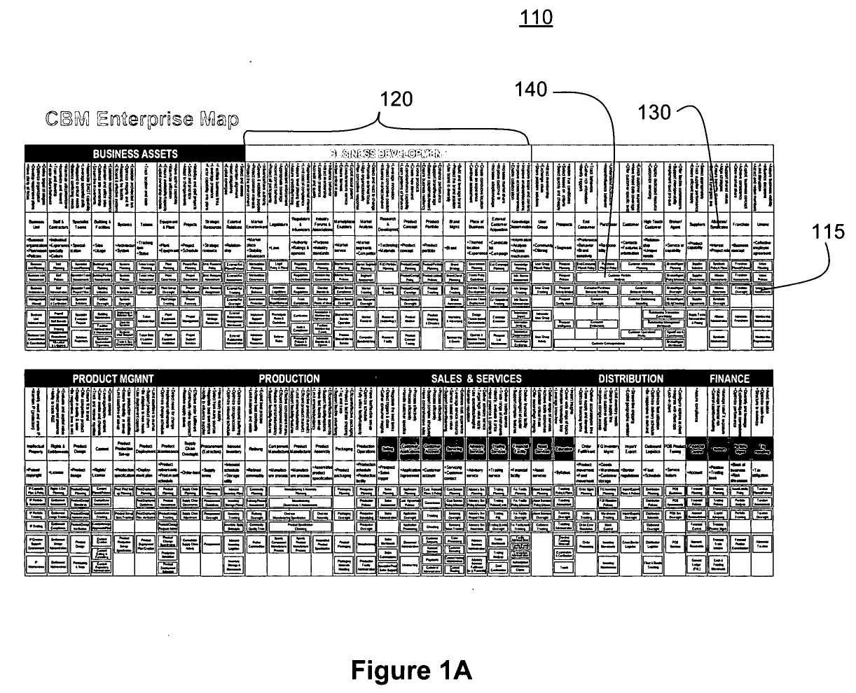

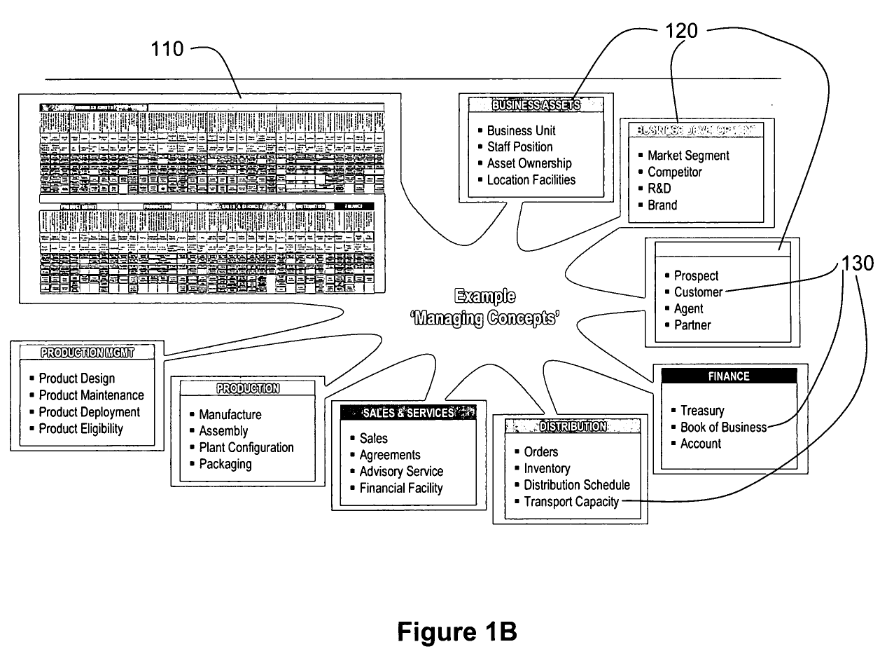

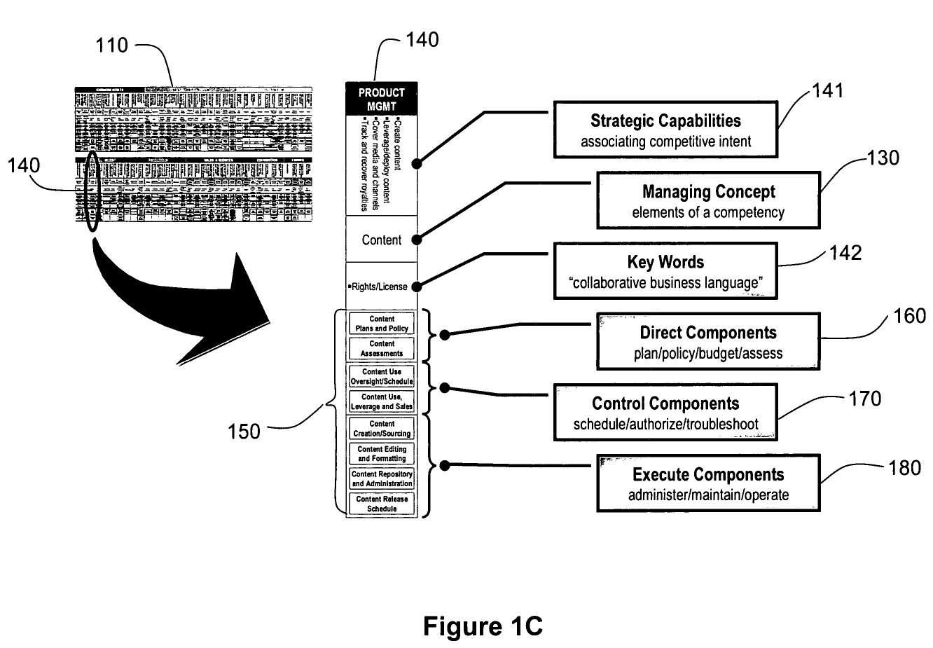

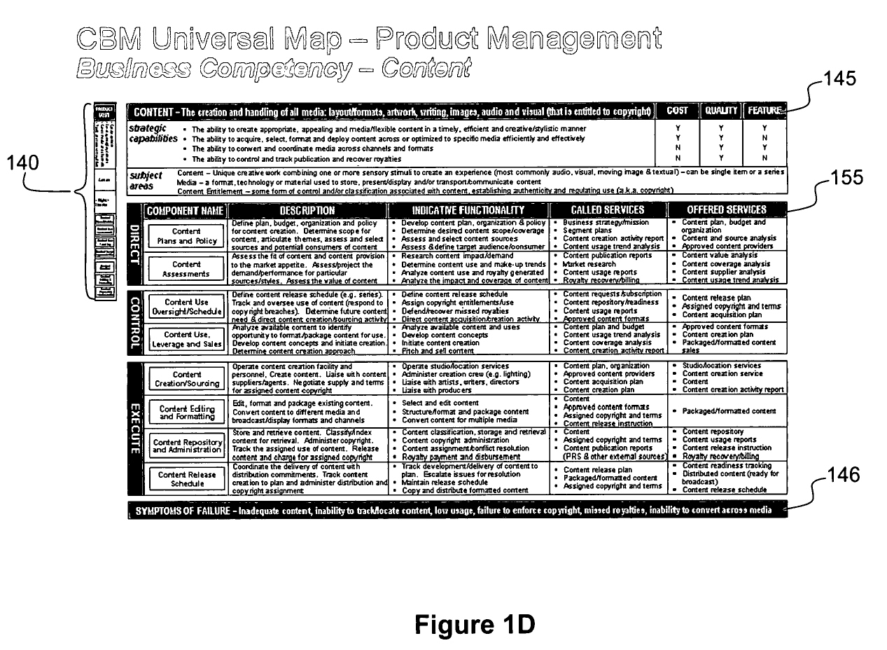

The invention provides a method to partition an organization into discrete specialist components. The structure representing these partitions may be understood with reference to FIGS. 1A through 1D. FIG. 1A shows a Component Business Model (CBM) enterprise map 110. This map is a high level representation of a repository of business components (e.g. 115) grouped into major categories (e.g. 120) of columns of distinct managing concepts (e.g. 130) having the characteristics more fully described below. The repository is universal, that is, it contains in one repository managing concepts and business components from across all industry groups. This does not mean that the repository is complete in its coverage of all industries. The repository, at each of its levels of detail and in each of its views, is the result of an iterative process. At the level of managing concepts and business components that have the characteristics required for operation of the invention, the repository retains the accumulated experience of a user of the invention in developing these managing concepts and business components. The need for an iterative process is evidenced by components (e.g. 140) that cut across multiple managing concepts. If managing concepts and components are defined correctly, there will be no overlap. Additional managing concepts and components may be added to the repository, in accordance with the characteristics of managing concepts and business components described below, as needed. In principle, however, there should be a limited and finite set of managing concepts, since they are bounded constructs that represent general mechanisms for the support of commercial enterprises.

For the universal repository and its high level CBM enterprise map 110, managing concepts 130 are grouped into the major categories 120 highlighted in FIG. 1B. The eight major categories shown (business assets, business development, constituents, finance, distribution, sales & services, production, and production management) are designed to cover all types of business activity in all industries. One way of looking at the term “managing concept” is to consider an on-demand business comprised of specialists assembled to execute the transactions required for the business. The objective is to isolate the organization mechanisms needed to support this type of arrangement. What are the elements that enable the various specialists to work together? These elements (e.g. an agreed vision or purpose; motivation and incentives; agreements and understandings; designs and concepts; organization, roles and responsibilities; skills and expertise; facilities, assets, raw materials; a common language to hold these elements together) are invented structures that we are calling “managing concepts”.

A “managing concept” is constructed by reference to a) a specified asset of the business and b) how that asset may leveraged for the purposes of the business. The asset may be tangible (staff, buildings and facilities, plant and equipment, raw materials, product components, packaging) or intangible (designs, blueprints, technical know-how, market reputation, authority, funding). A managing concept defines how an instance of an asset is controlled and coordinated within an enterprise. A managing concept is embodied by one or more mechanisms used to do something commercially useful with the asset: contain, operate, administer, or maintain the asset; organize and control the handling of the asset within the enterprise; direct the sourcing, deployment and assessment of the asset; and determine how the asset is defined and operated.

Each managing concept 130 is shown as a column on the enterprise map 110. The content of these columns is structured as shown in FIG. 1C, which shows an exemplar column 140 from CBM enterprise map 110, taken from the product management category. The managing concept 130 is shown, together with its strategic capabilities 141 with respect to the competitive market place, and also key words 142 which provide a common vocabulary for the service collaborations between components. This common vocabulary provides the language that all components can be assumed to understand within an industry, such that one component has enough language to infer and communicate through services with any other component. This common business language can be given unique interpretations within a component to support its internal referencing to the associated business concept. These internal and more detailed refinements are consistent with—and do not compromise—the commonality of the business language shared by multiple components across the enterprise.

The business components 150 which are the main body of the CBM enterprise map display are grouped into three management levels summarized as direct components 160 (i.e. components that serve to define policy, plans, goals, organization and budgets, and assess overall performance of the business), control components 170 (i.e. components involved with allocating tasks and resources, authorizing execution, applying policy, interpreting goals, and overseeing and troubleshooting performance), and execute components (i.e. components for administering, maintaining and operating the business).

Further detail contained in the repository and available as an expansion of managing concept column 140 is shown in FIG. 1D. The managing concept and its strategic capabilities are further defined and evaluated as shown in items 145 and 146. These are example strategic capabilities that can be refined and augmented to match the business strategy of a specific organization. Strategic capabilities are used as a mechanism for associating business intent with the desired performance of a competency and its supporting components. The business components are provided with a description, indications of functionality, identification of the services the component relies upon, and an identification of the services provided by the component, as shown in item 155.

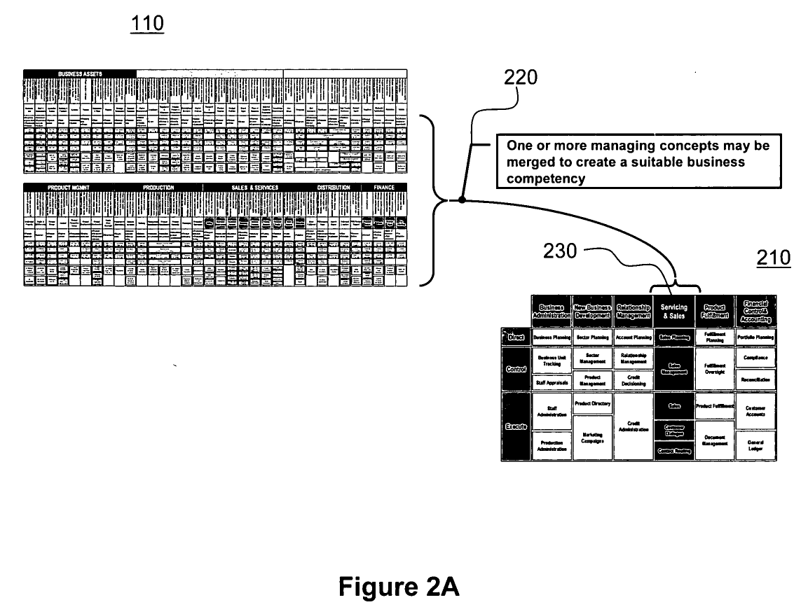

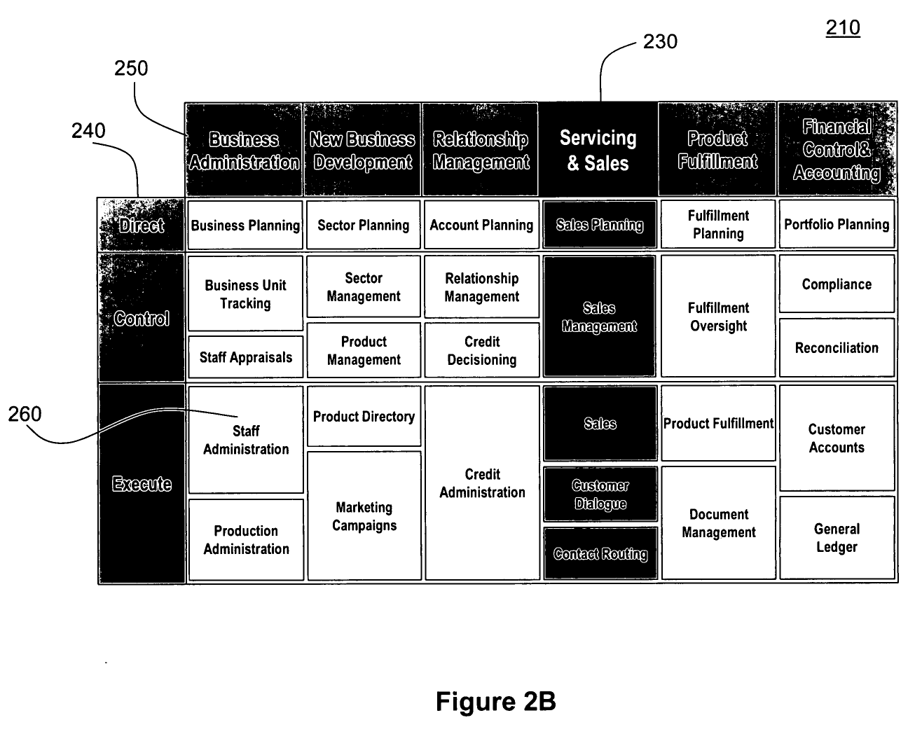

Thus, the repository provides a user of the invention with a place to accumulate information acquired over time, and the display structures described for the invention make this information accessible for reuse. The primary display structure for reuse is the CBM enterprise map 110 itself. As shown in FIG. 2A, the CBM enterprise map 110 is used to construct component maps (e.g. map 210) for particular businesses. These component business maps will typically use a subset of the managing concepts described in the CBM enterprise map 110. Furthermore, the columns in component maps for a particular business may combine 220 managing concepts to create a suitable business competency 230. It should be noted that many variations are possible in converting components from the enterprise map to a target component map for a business. Some components and managing concepts from the enterprise map may be omitted entirely. Components may be combined, or modified. For example, two logically distinct activities may be combined to reflect the small scale of the business. Also, generic components may be repeated where individual assessments are appropriate for separate instances. For example a generic component that provides ‘specialist advice’ may be realized with multiple versions for different types of advice. Furthermore, the terminology used to describe a general component may be adapted to match the prevailing language of the industry or the specific business without compromising its general definition.

Functional and non-functional ‘static’ features of a component that can be recorded in the general model and refined in industry or client specific versions with variations based on degrees of maturity or sophistication include (but is not limited to): functionality, organization, process structure, business services offered and consumed, supporting technology features, performance measures and metrics, existing capabilities, shortfalls, shortfall impact and corrective options, ongoing and planned activities to correct shortfalls and associated costs and justifications.

Functional and non-functional features and the ‘dynamic’ operation of combinations of components can be represented showing perspectives including the correct working of a component in response to multiple possible unrelated process oriented invocations. These representations can show how a component may participate in the execution of many different processes. They may also show how a combination of components may be invoked (broadly in sequence) in the execution of a specific business process. They can also show how a network of components may collaborate in an asynchronous and additive ‘cascade’ of responses to a specific event or trigger.

In the static and dynamic definition of a component it may be seen to fulfill one or a combination of collaborative roles including: an analyzer (were it defines the goals and assesses performance), a controller (where it makes specific decisions, tracks execution and reacts to divergence from the track), a processor (where it fulfils its responsibility in a chain of actions needed to complete a business process, a gatekeeper (where it orchestrates multiple, optionally interdependent threads of execution somewhat akin to a finite state machine), and a consolidator server (where it maintains and presents a perspective on a key business asset or perspective for the collective)

The repository maintains links to and from the CBM enterprise map, any intermediate industry maps, and maps for particular businesses, providing leverage for the accumulated experience of the user of the invention and facilitating the harvesting of solutions and insights regarding the objective of aligning a business with a component business model.

FIG. 2B is an enlarged version of the business component map shown in FIG. 2A. As shown in FIG. 2B, the business component map 210 lays out the individual building blocks of an organization in a matrix that defines the relative management level 240 and business competency (i.e. the broad functional specialization) 250. The three management levels 240 of direct, control and execute components were described above with reference to FIG. 1C. A business component (e.g. 260) is the basic building block of an organization. It is a cohesive group of business activities supported by appropriate processes, applications, infrastructure and metrics. Components are non-overlapping partitions of business activity, that is, components must have boundaries for their separate cohesive groups of business activities that are simultaneously coincident with respect to a) functional purpose, b) organizational role and authority, c) skill levels required, and d) operational and technical needs. Each component operates by calling and offering business services. The specialization and expertise of a component is encapsulated has far as possible. A component works under a managing concept, which is responsible for each instance of the component over the lifetime of the instance. Often, and preferably, a component defines a boundary with respect to other components that enables the component to be outsourced with little or no disruption of the business.

A component collaborates with other components through its business services, as will be shown below. Each column 250 in the map 210 represents a primary group of related business activities, which for the purposes of this invention will be called a “competency”. A goal of use of the invention is to partition the business into a non-overlapping and a collectively complete collection of competencies and components. A business competency addresses one or more managing concepts, and so each managing concept in the enterprise component map also must be non-overlapping, even if the set of managing concepts and components in the enterprise component map is not fully differentiated (since development of the enterprise component map is an iterative process). Nonetheless, notwithstanding further differentiation to develop a managing concept or component suitable for a particular enterprise, every component in a derived map will have a link back to an originating component in the enterprise component map. The strength and utility of the CBM model described in this invention comes from the partitioning of the business into non-overlapping components, managing concepts and competencies.

In a preferred embodiment of the invention the CBM enterprise map is used to construct intermediate level maps for particular industries. These industry specific maps are stored in the repository and are available from the repository as template industry component maps. Use of these intermediate maps provides an additional efficiency of reuse for the development of component business maps for specific businesses in a particular industry.

Components, as defined above, are the fundamental building blocks of the business. They are also the building blocks of the CBM repository. As described above, the CBM enterprise map 110 is the primary display structure for viewing the information stored in the repository. In order to enable additional display structures for viewing the accumulated information in the repository, the component building blocks may be annotated with a variety of attributes. One set of such attributes may be developed and applied for the purpose of establishing priorities for the alignment objective of the invention. In practical circumstances, a business that could benefit from such an alignment will have limited resources and a limited time frame for making investments in an improved alignment. The component business model provides a framework for structuring an analysis for prioritizing these investments. By applying an appropriate range of values for each of a suitable selection of attributes to the components of a business, display structures using these attributes and their values can provide a view of business components that will aid the user of the invention in recommending priorities within time and resource constraints of the business. As with other information developed within the component business model, these attributes and their values can be accumulated for reuse within the repository. Consequently, after a period of accumulated experience the determination of attributes and their values for a particular business for the purpose of setting priorities may be drawn in significant part from the repository, as viewed through appropriate display structures. It is important to note that the purpose of an attribute and its set of values will also be stored in the repository, so that display structures may be used appropriately. An attribute and set of values applied for one purpose may be distinct from a similar attribute and set of values applied for another purpose.

An example display structure reflecting a series of attributes and values applied for the purpose of prioritizing alignment options is shown in FIG. 2C. Since components are the basic building block of the business the object of a prioritizing exercise is to select for alignment attention “hot” components. Thus FIG. 2C is termed a “heat map”. As with prior component maps of a business, the columns 250 represent competencies and the rows 240 represent management level. The display structure of FIG. 2C overlays upon the component map the values associated with three attributes. Each component has been assigned a value for each attribute. One attribute and its three values are described in legend 270, reflecting an evaluation of the competitive properties of a component. At a base level (represented by a light shading) the component is being operated at a minimum level as a commodity, with no optional features. At a competitive level (represented by a medium shading) the component is operated to match the equivalent capabilities of peers in the market place. At a differentiated level (presented by a dark shading) the component is operated to establish a unique capability superior to peers in the market place.

This attribute (i.e. base/competitive/differentiated, or BCD) reflects an interpretation of the strategic intent, through an assessment of strategic capabilities associated with the corresponding business competency. The evaluative conclusions shown on FIG. 2C for this attribute (e.g. 280 showing a base level) may reflect a composite of evaluations of each of several abilities associated with a component. These more detailed evaluations may be applied using a display structure showing each of the particular abilities of a component and related information. With further application of suitable weights between abilities, a composite evaluation may be calculated. Preferably, the basis for the evaluation is stored in the repository for possible reuse.

The other two attributes are shown in legend 271. Resource consumption (indicated by the dark shaded block, e.g. 281) and performance criticality (indicated by the light shaded block, e.g. 282) are evaluated as high, medium or low. As with the competitive level attribute, these evaluations may also be built up from more detailed aspects of a component. For example, the resource consumption evaluation may be based upon a more detailed allocation of costs across components, which may in turn be based upon an allocation logic distributing costs across competencies and within a competency by a suitable component variable such as full time equivalent (FTE) staffing level.

The display structure represented by FIG. 2C is then used to inform a prioritization of components. Components selected as “hot” are indicated with a star symbol as shown in legend 271 (e.g. 290). This selection may reflect emphasis placed by the managers of the business on known problem areas

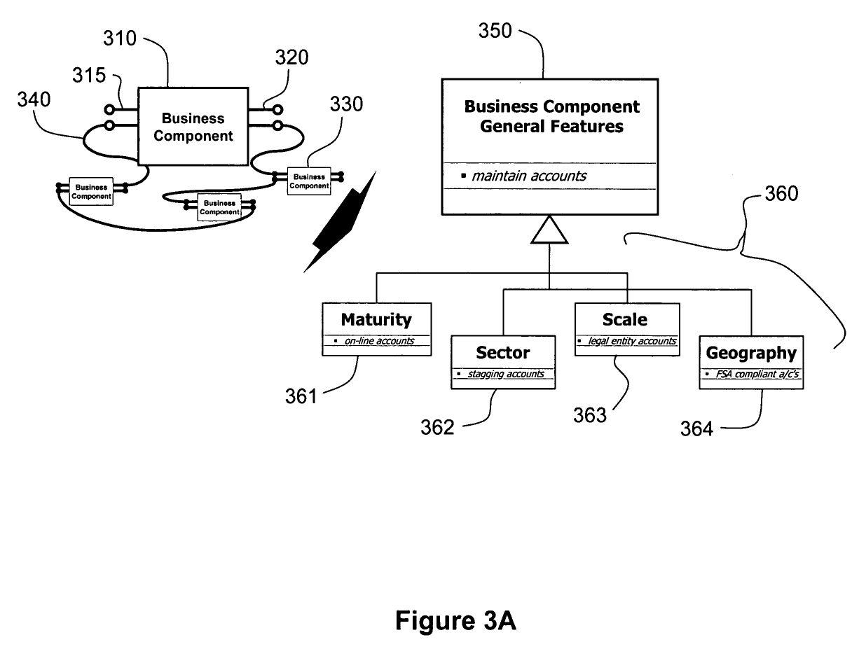

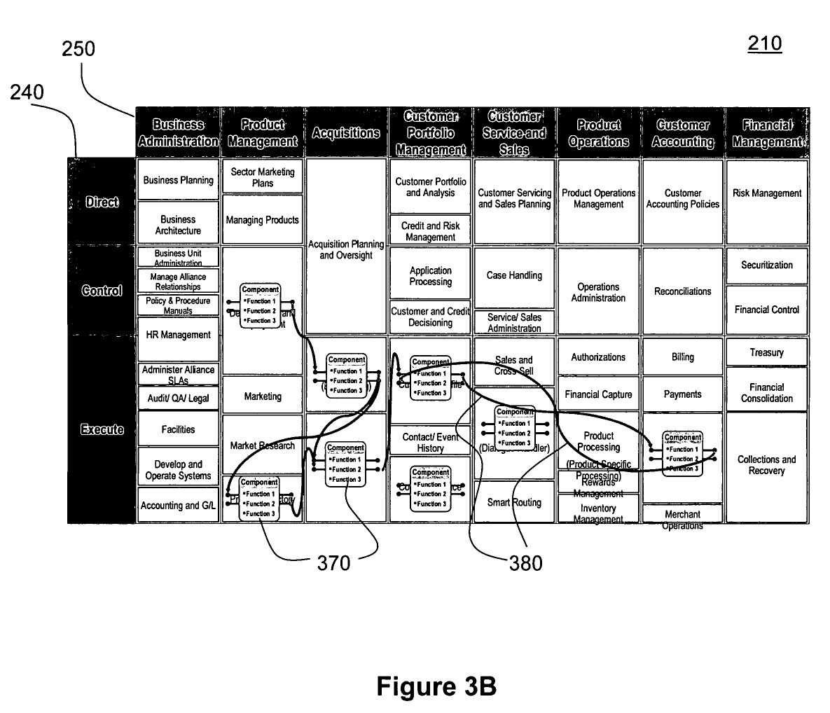

Turning now to FIG. 3A there is shown a schematic representation of a business component 310. A business component will receive services from other components, as represented by inputs 315 on the left side of component 310, and will provide services to other components, as represented by outputs 320 on the right side of component 310. A business component draws on services to enable it to fulfill its role and it offers services to other components in fulfillment of its role, but these inputs and outputs are asynchronous. That is, the services received are necessary for the component to provide services, but the services received and services provided are not linked in the sense of a common business transaction or process. Furthermore, a CBM component is a generalized design. In its realization a component can contain highly complex functionality, organization and supporting systems structures. This complexity is a specialization hierarchy defining possible refinements of functional and non-functional properties of the generalized CBM component to handle needs that may be specific to an industry (and therefore included in an industry map) or specific to a particular business (and therefore included in the component map of the business). These additional levels of complexity may be developed along dimensions such as maturity 361, industry sector 362, scale 363 or geography 364. The additional complexity of these various dimensions and others is represented schematically by item 360 in FIG. 3A. As needed, the encapsulated form 350 of the component may be displayed with an intuitive set of business services, or with further levels of detail.

A business component 310 will have a collaborative relationship with other business components (e.g. 330), and this relationship may be understood in terms of the services provided and received (e.g. 340) in a collaborative network of components. The information specifying services received by a component and services provided by a component, as described above with reference to item 155 in FIG. 1D, is maintained in the repository. Consequently, the collaborative network of components may be displayed as an overlay upon a component business map, as shown in FIG. 3B. FIG. 3B shows a component business map 210 as a matrix of components arrayed by competencies 250 and management levels 240. In the overlay shown in FIG. 3B, the components (e.g. 370) in the collaborative network are linked together (e.g. 380) by lines connecting a service output to a service input.

It is important to understand the connection between the above described model and component map for a business and the actual state of the business for whom the model is developed. The component map described above is a target state of the business, reflecting the accumulated technology for component business models contained in the enterprise component map 110 and the repository, as adapted to describe a particular business. The target component map incorporates the characteristics described above for components, managing concepts and competencies. For the purposes of this invention, these terms (component, managing concept, and competency) are to be understood as defined by the above described characteristics.

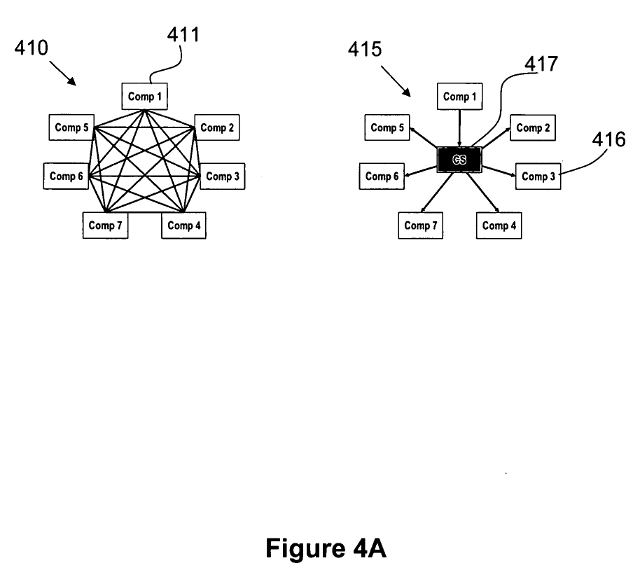

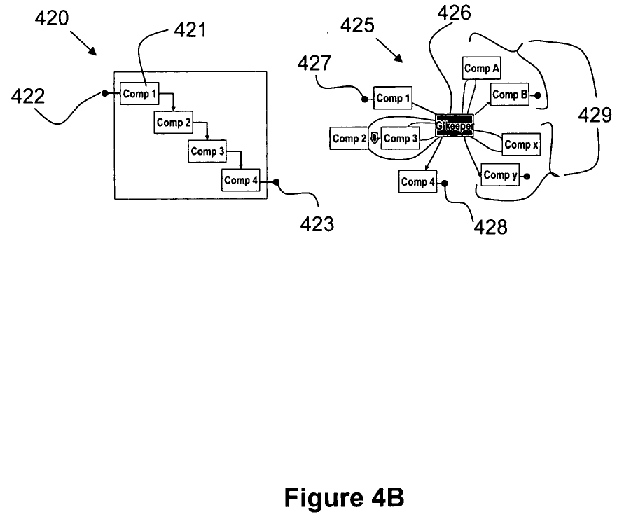

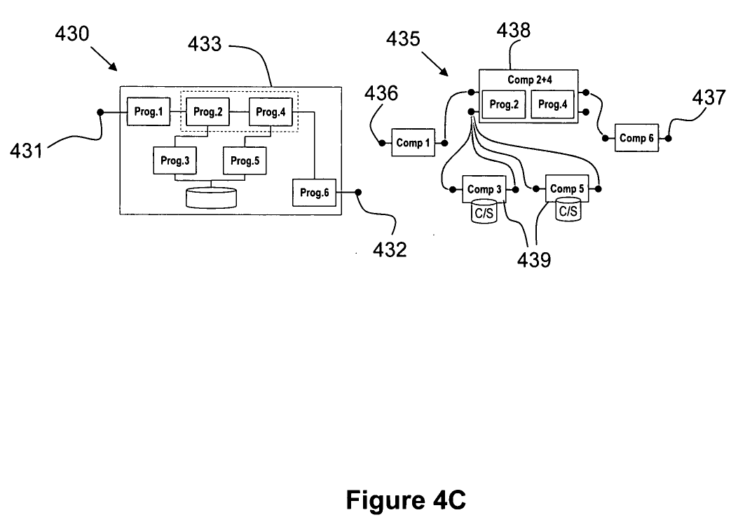

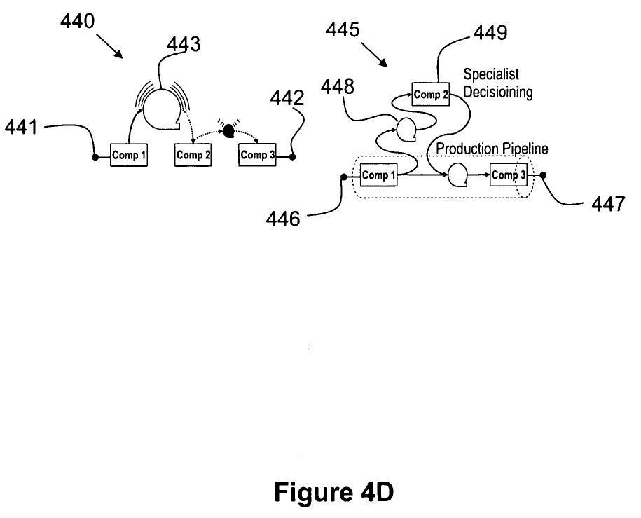

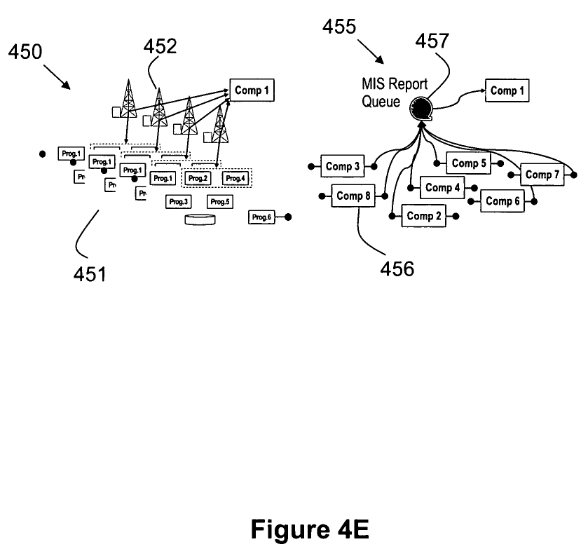

The collaborative networks described by the invention provide an analytical basis for improving alignment of the business to a component business model by reconfiguring the collaboration. By reconfiguring the collaboration between components, the components themselves, and their respective competencies, will become better aligned to the component business model. In particular, by reconfiguring business activities in the form of components and simplified collaborative patterns, the result will be components that are more independent and less overlapping, with better defined means of working with each other. These reconfigurations in accordance with the invention include the following five types of collaborative patterns for the roles of components in the execution of processes, which will now be explained with reference to FIGS. 4A through 4E. Three of these are easily equated with a process viewpoint, and two relate specifically to the collective view of processes across a collaborative service network.

FIG. 4A shows a reconfiguration of components who share information or services with the other components in the collaborative network, but independently as shown in diagram 410 where each component (e.g. 411) has direct links to the other components. In the revised configuration 415 a consolidator/server component 417 is added to the collaborative network, simplifying the connection between a component (e.g. 416) and any other component in the network. Consolidator/Server components provide a single access point for widely referenced information and/or services. The role of the component is to reduce the number of connections needed to reference and maintain information and so to improve the simplicity and consistency of business activity. When information is maintained independently in many locations there is increased potential for error and the need for significant connectivity to ensure changes are coordinated.

Before the reconfiguration, as shown in 410, similar information and services are developed where they are needed and peer connectivity is used to coordinate changes. After the reconfiguration, as shown in 415, all users reference a specialist component, using common services to reference and update the information. Components may maintain local copies of information for performance purposes with a number of possible protocols used to update or reference the specialist component (e.g. access when required, broadcast changes, periodic update of local copies).

Consolidator/server components 417 may be developed from a legacy application or more typically are supported by new purpose built systems. Referencing components can retain their local data structures to limit internal change, but local maintenance logic is removed and replaced by service access routines that reference the specialist component. These may include local encapsulation or wrappers for isolated conversion. The result of the reconfiguration is reduced complexity (multiple links between peer components are eliminated), improved responsiveness (changes in one area are captured centrally and relayed to other subscribing components), improved quality (errors are reduced because central governance eliminates double updates and inconsistency), and enhanced capabilities (single specialist service component supports focused incremental development of enhancements).

FIG. 4B shows a transition from a pre-defined collaborative process 420 to a more flexible collaboration 425 able to respond to situations not contemplated by the predefined process. In the pre-defined process 420, there is a trigger or input 422 followed by execution of the process by the various components (e.g. 421) in the pre-defined collaboration, with a result or output 423 at the end of the process. In the revised configuration 425 a gatekeeper component 426 is added, making available intermediate results or outputs that can be used by other component collaborations 429, in addition to result or output 428 in response to trigger or input 427. Gatekeeper components, such as 426, oversee access to other components for complex business transactions where different situations may require different responses. The gatekeeper component 426 seeks to ensure that all necessary tasks and all possible opportunities to leverage an event are exercised in an optimised combination or sequence

Before the reconfiguration business events are processed following a pre-defined approach, and optional tasks are not always identified and exploited. After the reconfiguration business events are ‘gang tackled’ leveraging all facilities and exercising all applicable tasks viewed across the enterprise. Gatekeeper components are triggered by an event, such as a customer contact, following a decision making logic to invoke as many activities in parallel and in an optimal sequence to respond. In addition the gatekeeper component will determine whether the triggering event presents an opportunity to launch other responses (such as cross-sell) or progress pending tasks (such as deliver mail)

Gatekeeper components will more typically be purpose built but may consolidate decision making logic from legacy systems. Their development needs to be incremental as new services are enabled with the development of processor and consolidator/server components. Decision making logic may be migrated from legacy applications as they are re-purposed. One advantage of migrating to gatekeeper components is each business event is fully leveraged to invoke all applicable components and pending processes. Another advantage is improved responsiveness, since business rules can be streamlined and optimised to provide optimal response. Further, additional flexibility is provided because tasks which are not inherently in a particular sequence are decoupled, allowing execution in parallel and allowing these tasks to be sequenced in an event driven or state driven manner.

FIG. 4C shows a transition from a monolithic processor configuration 430 to a revised configuration 435 which separates processes and links them in a collaborative network. In this transition a monolithic processor 433 with trigger or input 431 and result or output 432 is broken down into a streamlined processor component 438 linked to other components (e.g. 439) providing necessary services. The streamlined processor component 438 continues to produce the desired output or result 437 in response to input or trigger 436. Processor components (such as 438) are specialised processing facilities. They are similar to traditional processing facilities, except that the component is reduced to include only the specific functionality needed to fulfil its role, with all other required services provided through collaborations with other components. It is also necessary that the processor component present a standard supply or subscription service interface so that it can be invoked from any other component as appropriate.

Before the reconfiguration processing is performed by a monolithic processor that contained within itself all associated services and imposed a rigid workflow. After the reconfiguration, processing is streamlined, tasks are generalised and de-coupled, and specialized generic services are leveraged. Processor components configured as described above reduce processing of the component to a streamlined minimum, referencing consolidator/server components for common information and services and linking with other processor components, optionally through the oversight of gatekeeper components to execute a business transaction. By decomposing processing into generalised tasks where possible, re-use is maximised. In practical terms, this provides ‘service-enabled’ processing, thereby maximizing flexibility since constituent components can be ‘wired’ together in any working sequence or combination.

Processor components will frequently be re-purposed legacy applications. Re-purposing will be a combination of breaking the legacy application into component aligned modules, wrapping these modules in a supply or subscription service interface and extracting and remotely referencing any functionality that is better supported by a consolidator/server component. The advantages of this technique are reduced complexity and improved performance (a processing component is reduced to an optimised processing minimum), improved re-use (a streamlined component provides a generalized service), and improved flexibility (i.e. a streamlined processor component is enabled as a service).

FIG. 4D shows a transition from a configuration 440, where an execution step requiring special attention is imbedded in a sequence, to a revised configuration 445, where the special attention step is extracted from the sequence pipeline for performance by a controller component. Prior to the transition the process sequence includes a step 443 between input 441 and output 442 that cannot be routinely resolved. Transition to collaborative pattern 445 involves extracting special attention step 448 and creating a controller component 449, removing uncertainty and delay from the production pipeline between input 446 and output 447.

Controller components oversee the execution of business. They perform checks, classification or qualification activity, handle exceptions and detect and resolve issues arising in execution. Controller components will typically support the oversight functions of line and will leverage information and technology to support operational decision making. Before a configuration change creating a controller component, checks and exceptions requiring specialist or senior staff involvement are tightly bound into execution, or are poorly supported, causing uncertainty and delay. After a suitable controller component is added, checks and exceptions are isolated from execution and routed to a specialist or senior decision making resources for resolution using suitable facilities.

Controller components both monitor execution activities and can be triggered by business events and exceptions. Checks may be required at certain times, due to certain situations or when thresholds are breached. Most typically a controller component will execute independently (asynchronously) of execution tasks, taking pending actions off and returning results to work queues. Where they support complex decisions they may invoke other controller components in the resolution of an issue. Controller components will more typically be purpose built but may consolidate decision making logic from legacy systems. Their development needs to be incremental as new services are enabled with the development of processor and consolidator/server components. Decisioning logic may be migrated from legacy applications as they are re-purposed. Controller components provide a point of focus for future incremental development, supporting ever more sophisticated decision making capabilities.

Controller components provide improved productivity by decoupling checks and controls from execution, thereby streamlining production. They also improve the leverage available from specialist resources by directing issues to facilities and individuals best qualified to address them. Further, controller components provide improved flexibility, since incremental development and collaborations between Controller components are highly flexible and scalable.

FIG. 4E shows a transition from a configuration 450 where production information (e.g. 451) is mined 452 in order to support management decision making, to a configuration supported by analyzer components (e.g. 456) providing standard management information system (MIS) extracts to an MIS report queue 457 available to decision makers. Analyzer components support decision making at the management level served by “direct components” (see discussion above regarding component maps) for determining how the business is to be run and evaluating performance. They present consolidated and historical business information, optionally supported by externally generated market information to support policy making and business direction. Analyser components can support scenario development, sensitivity analysis planning and consolidated business performance tracking.

Before the configuration 450 is changed, senior management decision making is constrained by the quality and timeliness of business information and the supporting analysis tools. After configuration 455 is implemented, key activity information is extracted and consolidated from control and execution components in standard formats with full analysis facilities. Analyzer components absorb summary business activity details over time. Standard message formats, schedules for extracting the desired information, and mechanisms for automating and standardizing the extract process ensure consistent information is used to direct the overall activity of the business. Some return reporting to the business from the Analyser components can be supported to communicate policies, budgets, goals priorities etc., though the benefits of automating such flows are less significant.

Analyzer components will more typically be purpose built but may consolidate existing reporting and analysis logic from legacy systems. Their development needs to be incremental as new activity information becomes available with the development of controller, processor gatekeeper and consolidator/server components. Improved business decisions flow from this configuration change, since improved quality and timeliness of business activity information supports better decisions. Also, analyzer components provide improved responsiveness because tighter feedback loops support more interactive policy development and business direction.

The target component map is the basis for developing a roadmap of tasks to migrate the business from its current state to a state that is better aligned with the target component map, and therefore better aligned with the component business model.

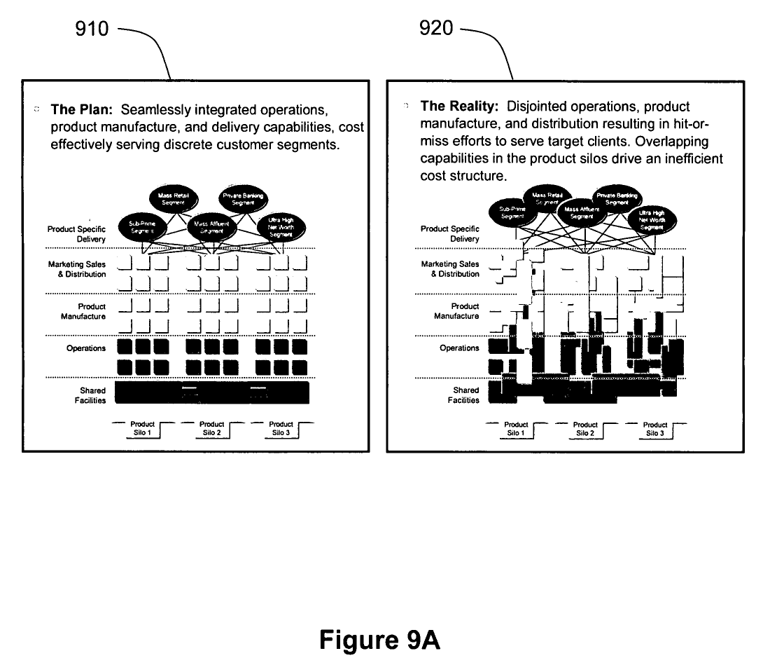

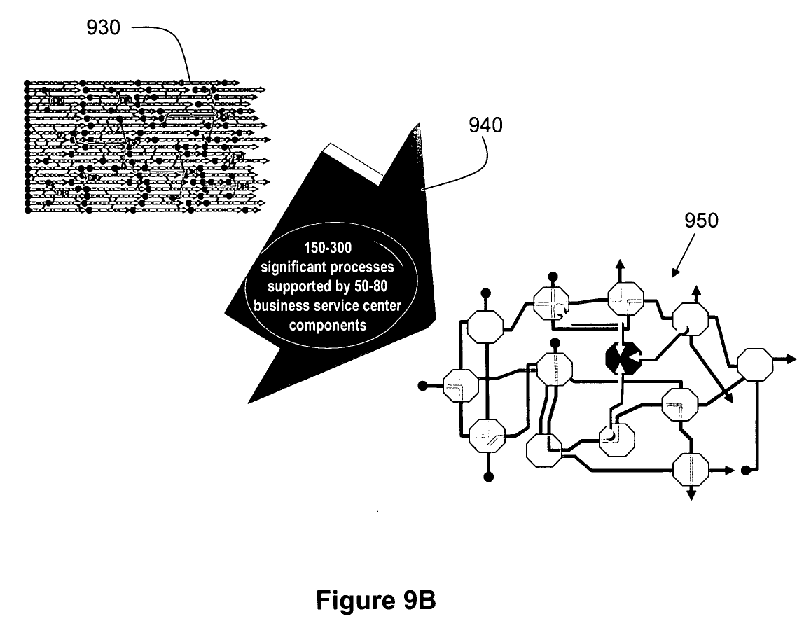

The significance of these improvements for an on-demand computing environment may be understood from FIGS. 9A and 9B. Systems investment typically addresses evolving business needs incrementally—extending existing facilities as needs arise. The result is an application architecture with point to point interfaces and duplicated functionality. The systems fragmentation is compounded when the organization attempts to add new products into the mix. The result is solutions built with the narrow perspective of single process improvements building on one another, leading to overlapping and redundant business systems. As conceptualized in FIG. 9A, the plan for system investment is not matched by the reality. The plan 910 is for seamlessly integrated operations, product manufacture, and delivery capabilities, cost effectively serving discrete customer segments. But the reality 920 flowing from a succession of incremental improvements from a narrow perspective is disjointed operations, disjointed product manufacture, and disjointed distribution resulting in hit-or-miss efforts to serve target clients. Overlapping capabilities in product silos drive an inefficient cost structure. Experience under the prior art indicates that this reality is worse for larger businesses. The overheads of maintaining and evolving using this narrow incremental approach can be prohibitive, with organizations spending 5% or more of their revenues on basic maintenance and essential implementation work.

The present invention provides a novel view of the business, enabling significant simplification and clarity of analysis. For example, consider the situation referred to in FIG. 9A, where a narrow perspective of single process improvements resulted in a complexity that was particularly inefficient for large businesses. The process view 930 is transformed 940 by the present invention, as shown by the example represented in FIG. 9B, yielding a component perspective 950 having a reduced number of components through which the larger number of processes 930 may be analyzed. The present invention identifies a collection of business service centered components that in combination support the full array of possible processes 930. A representative collection from the full array of processes 930 is then run across the component network 950 to clarify the roles and outline the service boundaries of key components

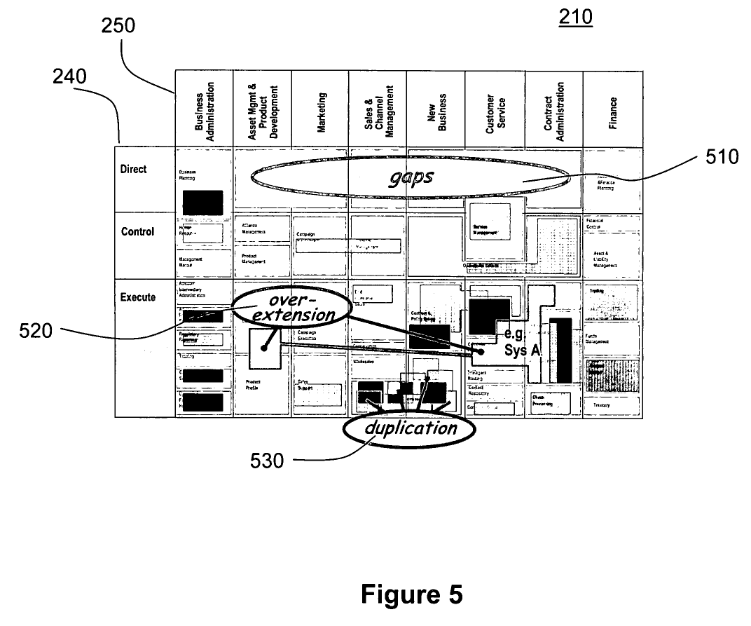

The difference between the target component map and the current state of the business may be understood with reference to FIG. 5. In general, three generic issues will arise in using a component viewpoint to assess the shortfalls between the current state of the business and the target component map. Current systems, processes and organizations are matched to more detailed specifications of the business components functional and non-functional features and the collaborations between components contained in the target component map. FIG. 5 is a schematic representation of a current systems overlay upon a target component map for a business. The value of components in this overlay is to define a bounded area of functionality for which overlapping systems with different ‘footprints’ can be compared in an ‘apples to apples’ manner. The target component map provides the underlying ‘footprint’ and the current state of the business provides an overlay ‘footprint’. While the following discussion with reference to FIG. 5 is addressed, by way of example, to technology systems, it should be understood that similar overlays can be useful for examining the current ‘footprint’ of other assets and organization structures of the business, including business organization units, staffing assignments, and other resources allocated to the business.

An assessment of shortfalls between the current state of the business and the target component map is facilitated by the overlay, a display structure which highlights three generic issues that tend to arise in the systems shortfall assessment. There are gaps 510, where the current system lacks key functionality required by the target component map, or where the current system is poorly designed. Legacy systems are compared for suitability for individual components in order to identify systems that could be foundational, as compared to those that may need to be decommissioned. A second generic issue is duplication 530, where multiple systems compete for the same need. By using the component map to place current systems with the components they serve, these duplications are easily identified. The third generic issue is over-extension 520, which indicates that a system designed to support one component has been extended to help support other components where its technical architecture is not optimal. Associating current systems with components on the component map clarifies where these over-extensions are and form a basis for suggested transformations that will improve modularity and flexibility of the business.

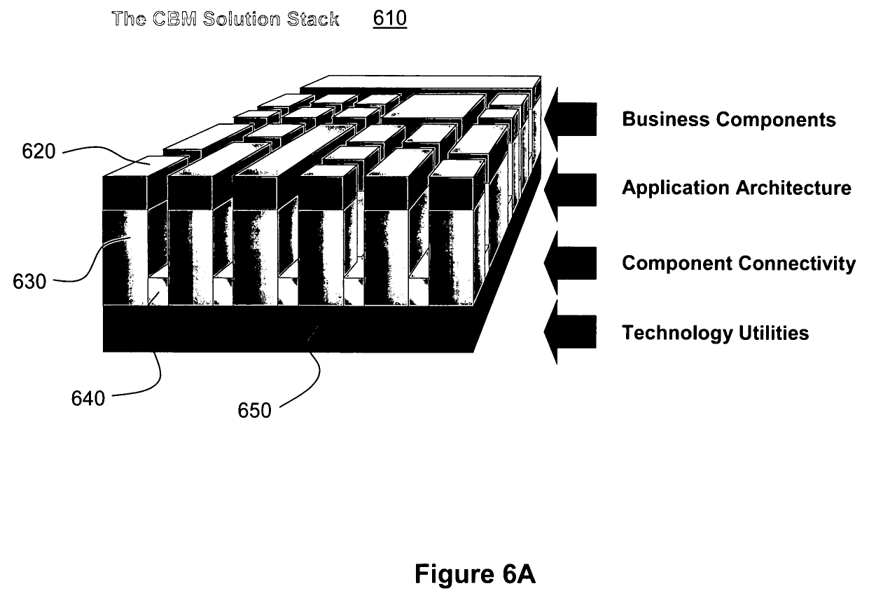

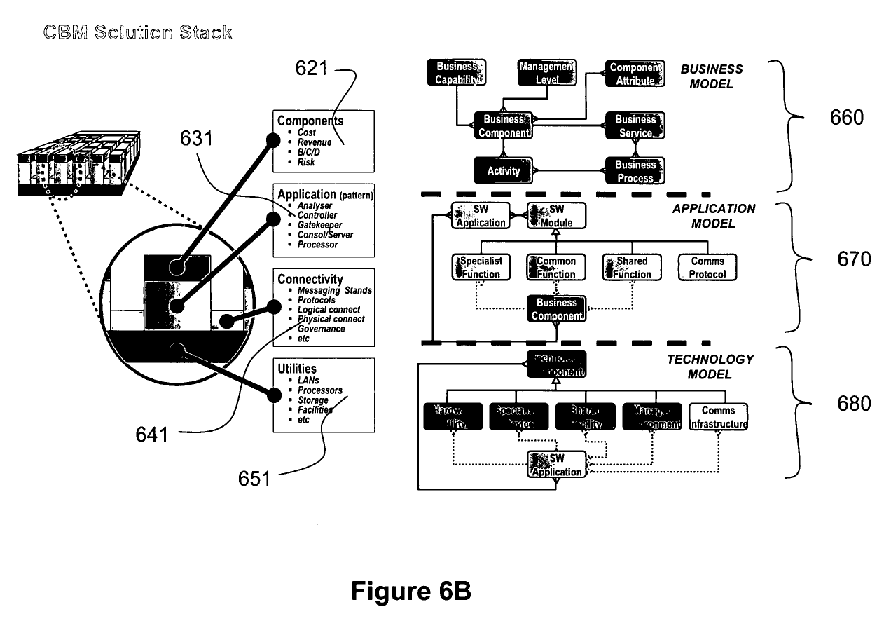

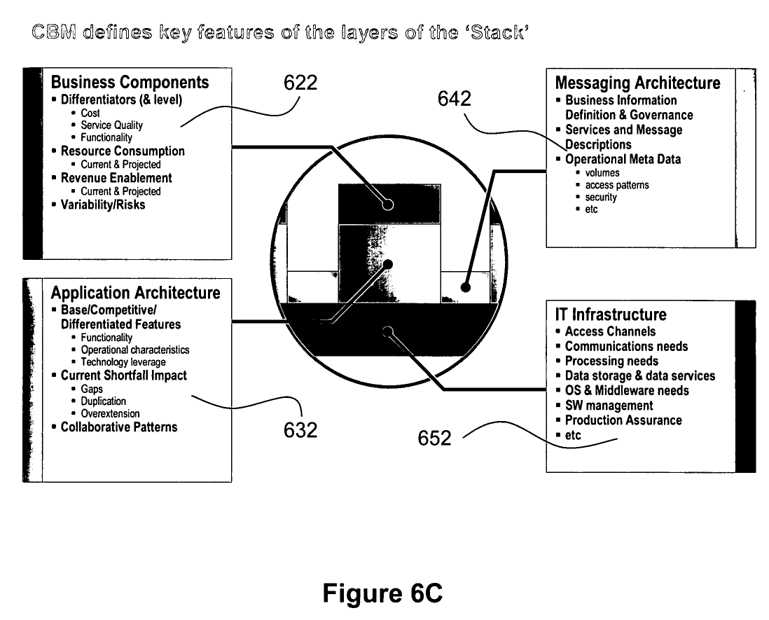

A further display structure of assistance in the objective of aligning the business to a component business model is a three dimensional structure which will be termed a CBM stack. The CBM stack will now be described with reference to FIGS. 6A through 6C. As shown in FIG. 6A, the top level 620 of CBM stack 610 represents the implementation projects for aligning the current state of the business to the target component map. These are mapped as an overlay upon the target component map, and are stored in the repository in association with their respective components. However, the representational structure of the component business model, components, managing concepts, and competencies simply provide views of the business that have proven to be instrumental in identifying opportunities for investments which improve the business by better aligning the business with a component business model, as that term is described above. Actual implementation must be translated into the application architecture 630 of the business, with appropriate allowance for component connectivity 640 and the underlying technology utilities 650.

These layers of the CBM stack are further described in FIG. 6B, which identifies some of the consequential details of implementation associated with the component layer 621 (cost, revenue, competitive level, risk), the application layer 631 (collaborative patterns: analyzer, controller, gatekeeper, consolidator/server and processor components), the connectivity layer 641 (messaging strands, protocols, logical connectivity, physical connectivity, governance), and the utilities layer 651 (local area networks, processors, storage, facilities). The implications of the CBM stack are also reflected in a business model 660, an application model 670, both of which are logical models, and a technology model 680 which is physical. The role of CBM in defining the key features of the CBM stack is shown in FIG. 6C, these features being distributed between the business components 622, application architecture 632, messaging architecture 642 and IT infrastructure 652. These features are defined in the CBM model and are reflected in the content stored in the repository. The CBM stack display structure is helpful in clarifying and organizing the full scope of activities necessary to implement an alignment.

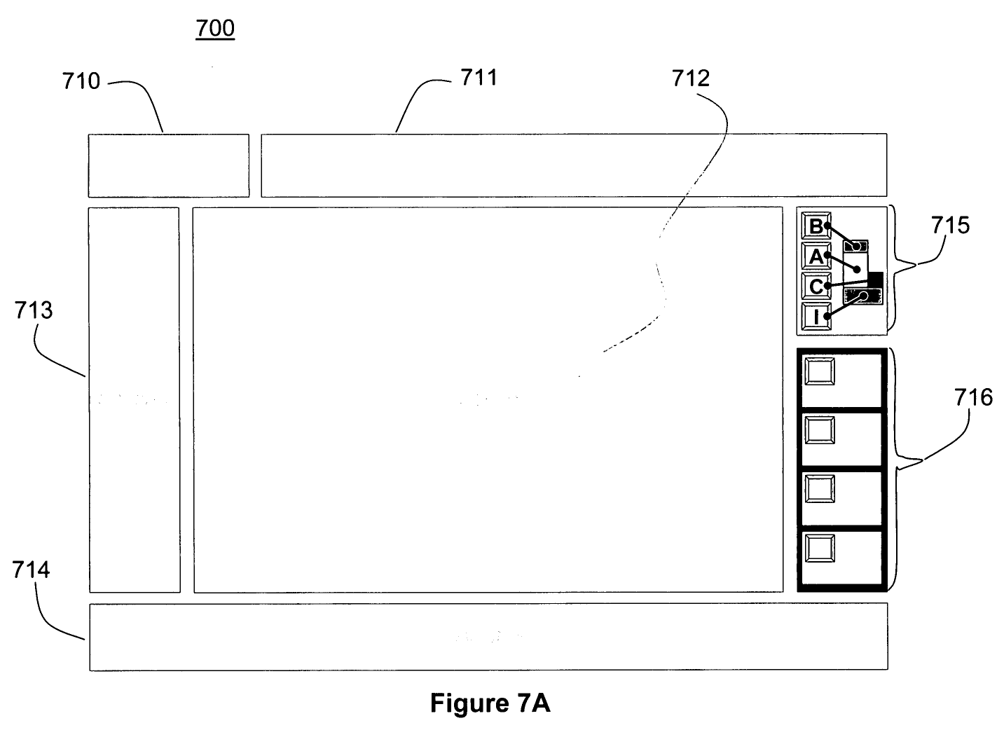

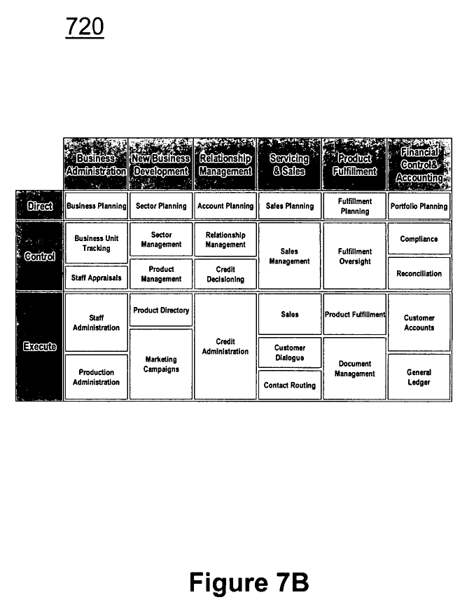

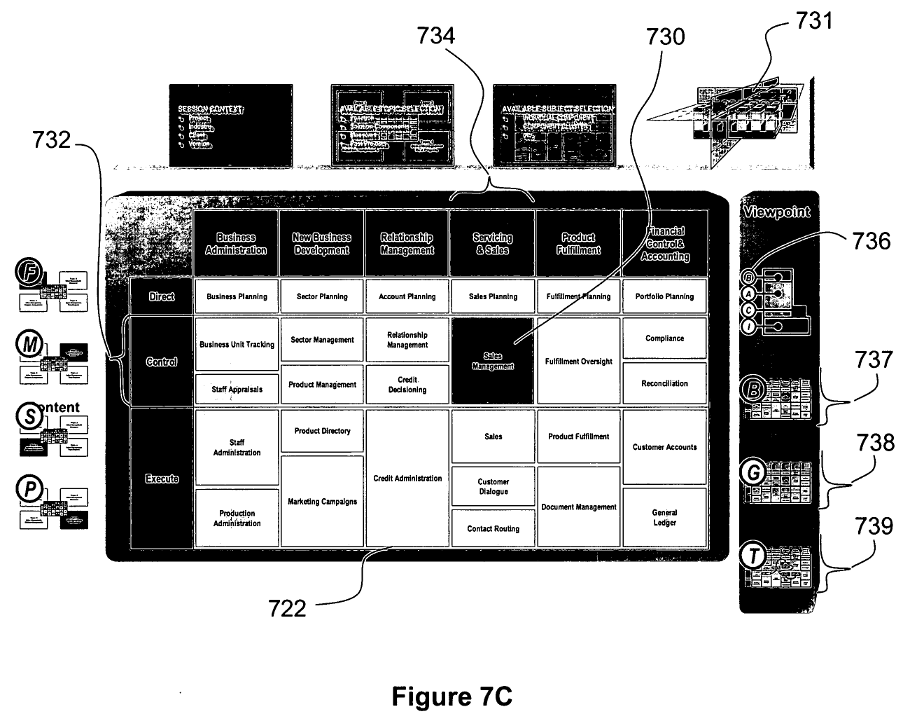

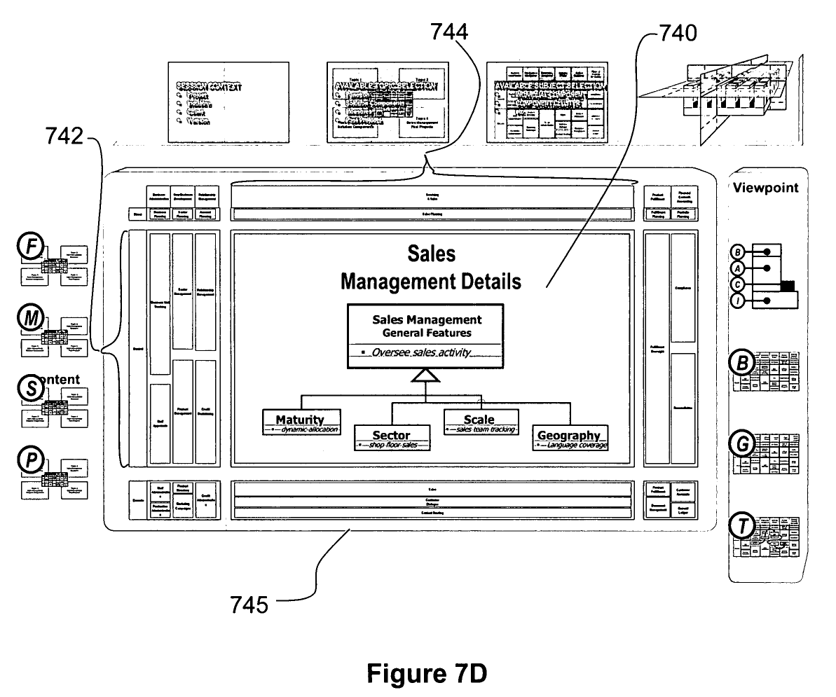

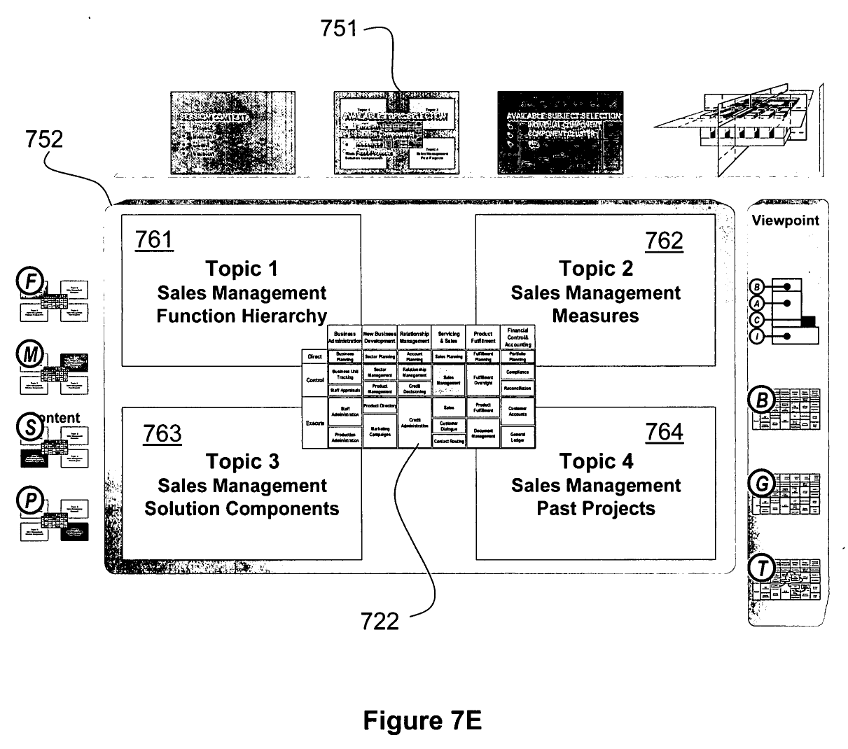

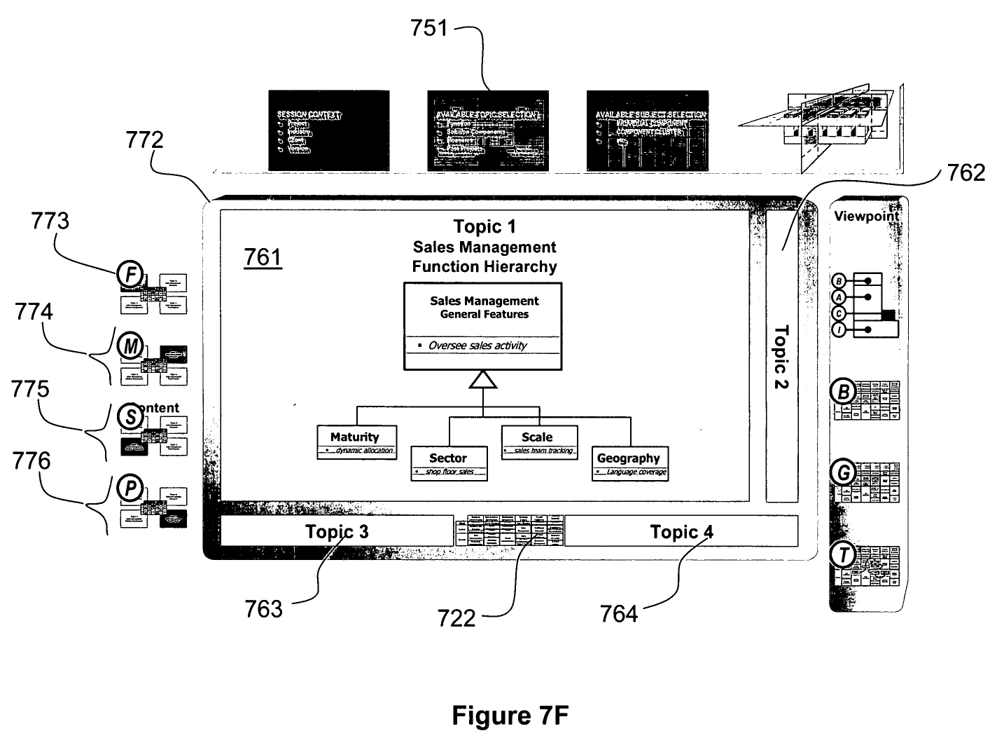

Navigation through the information contained in the repository is enabled by the structure of the CBM model, as revealed by the display structure and display mechanisms shown in FIGS. 7A through 7F. The component boundaries in the CBM model provide a consistency across the different levels of the CBM stack (i.e. business logic, application logic, and technical infrastructure). This consistency of component boundaries stands in contrast to traditional approaches, which use different formats at the different levels. The different formats, apparently tailored to particular levels, create an ‘impedance mismatch’ between levels. This mismatch between levels limits the integrity of a traditional requirements analysis that purports to consider all levels of the business.

FIG. 7A is a diagram showing the elements of the display structure. At the center is a display element 712, whose function will be elaborated below. Around the display element 712 are a session element 710 (which indicates the project being serviced by this navigation session), a context element 711 (which indicates whether you are looking at an enterprise map, a sector map, or a client specific map), a group of level buttons 715 allowing selection of the business (B), application (A), communication (C) or technical infrastructure (I) level of the CBM stack. The next group of buttons 716 indicate whether the user is looking at one component, a selection of components (based on some criteria), a transaction (involving several components) or a pattern (e.g. of networked collaboration among components). Then there is an element for selection of display options 713, within the selected context 711, selected map level 715 and selected component or grouping 716. Then there is a display element 714 for actions the user may take with respect to the contents of the display element 712, such as entering information or making decisions that are not simply navigating through the various display options.

FIG. 7B shows the component map 720 which will be used in this series of figures. This component map 720 is the contents of the display element 712 as shown in FIG. 7C. The “sales management” component 730 is highlighted, and it is noted that this component is within the “servicing & sales” 734 competency column and the “control” 732 management accountability row. The selected viewpoint 715 is the business level 736 of the CBM stack, and selected focus 716 is the business component 737 (as opposed to group 738 or transaction 739). Note that a three dimensional view 731 of the CBM stack will adjust to reflect the respective dimensions of the management accountability level 732, competency 734 and viewpoint 715 of the selected components, thereby providing the user with an overall perspective on where he is in the navigation.

It is important that the display structure 700 be able to show detail yet at the same time maintain context. FIG. 7D shows a display mechanism called “grid shift” for allowing the display of another level of detail 740 for the selected component 730 while preserving the context. This is accomplished by shifting the scale of the row 732 and column 734 of selected component 730 shown in FIG. 7C so that the selected component is expanded and the non-selected elements are contracted, as shown in FIG. 7D by the expanded row 742 and expanded column 744, providing room for greater detail 740, showing the general features of the “sales management” component.

A different way of navigating to this information is shown in FIGS. 7E and 7F, using the topic context 751 and the options 753 associated with this context selection. The display element 752 reflects the selected context element 751, and contains the component map 722 having the “sales management” component selected, surrounded in a “clock face” display by several topics having more detailed information about the selected component. Topic 1 (761) contains a function hierarchy, topic 2 (762) shows measures, topic 3 (763) shows solution components, and topic 4 (764) shows past projects. While this exemplar “clock face” display has only four topics, other such displays may have more topics, spread over the available polar coordinate space around the component map 722, arrayed like the hours on a clock face. Note that the number of “clock face” options will correspond to the number of options provided in the options element 753, which may vary with component selected and viewpoint selected. For example, if the “viewpoint” selected were “applications” instead of “business”, the topics would relate to the computer applications affecting the component. Similarly, if a group of components 738 were selected, the topics would relate to information pertaining to the group (e.g. a process common to the components in the group). Another example would be if a pattern (not shown in FIG. 7C, but included generically as item 716 in FIG. 7A) were selected, the topics could be each of the components participating in the pattern.

FIG. 7F shows in the display element 772 a “grid shift” version of the information displayed in FIG. 7E. This reflects selection of the function hierarchy option 773. The “grid shift” display is topologically equivalent to the display in FIG. 7E, but the bulk of the available space in the display element is allocated to the selected topic 761. The other topics and the component map 722 are still present, but in reduced form, allowing display of the detail in the function hierarchy topic 761. Note that the user could select 774 the measures topic 762 and show detail on that topic. Similarly, the user could select 775 the solution component topic 763, or the user could select 776 the past projects topic 764. Note further that the general features of the sales management component displayed in the “grid shift” topology shown in FIG. 7F is the same content as the general features detail displayed in FIG. 7D. But the context is different, and consequently the navigation options enabled within the different “grid shift” displays will be different.

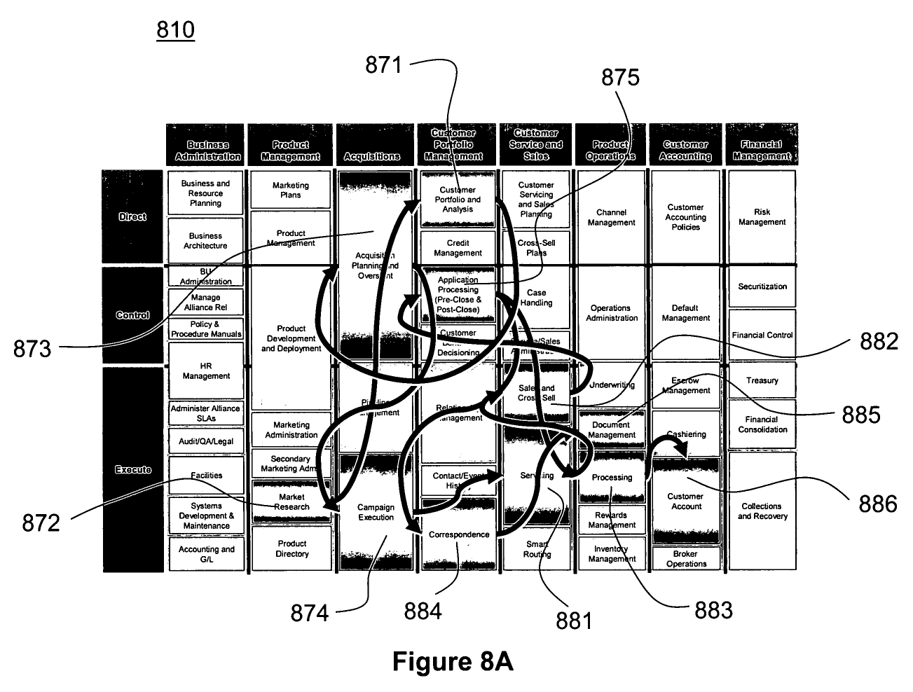

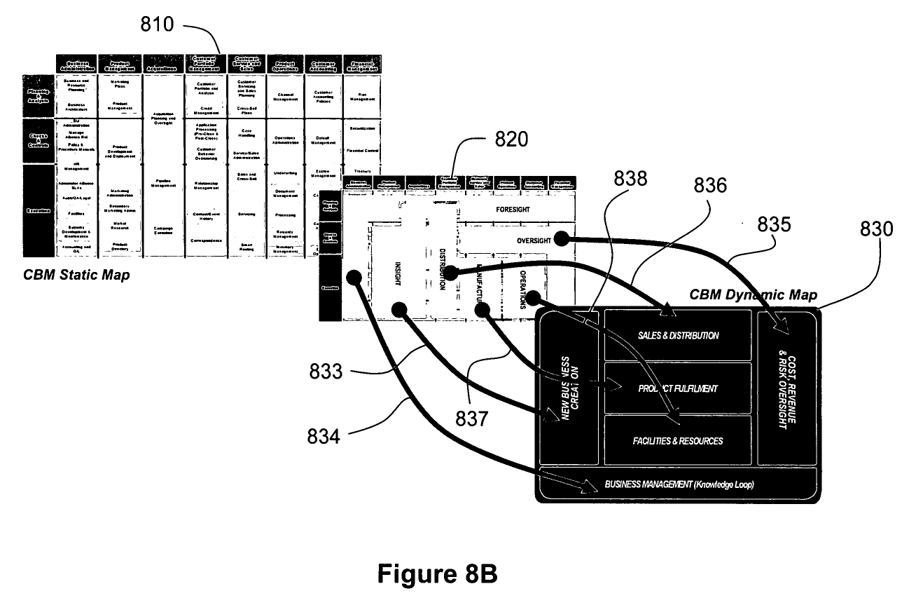

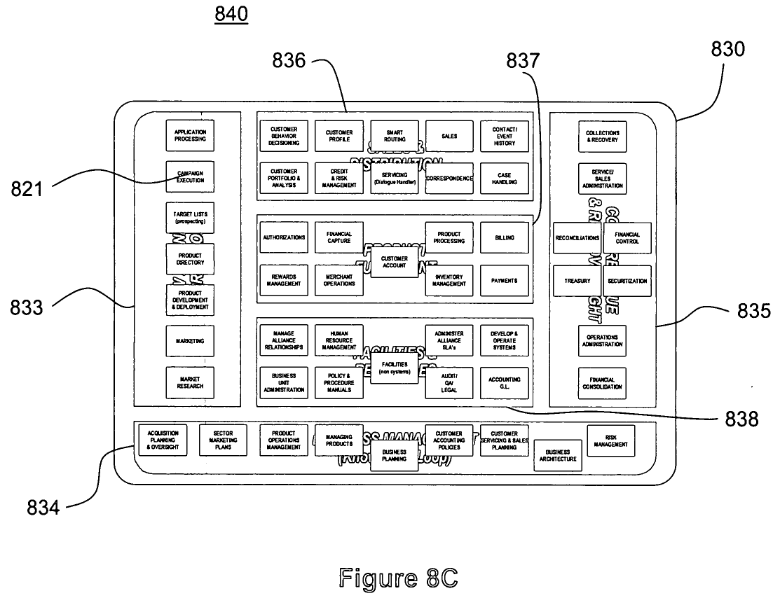

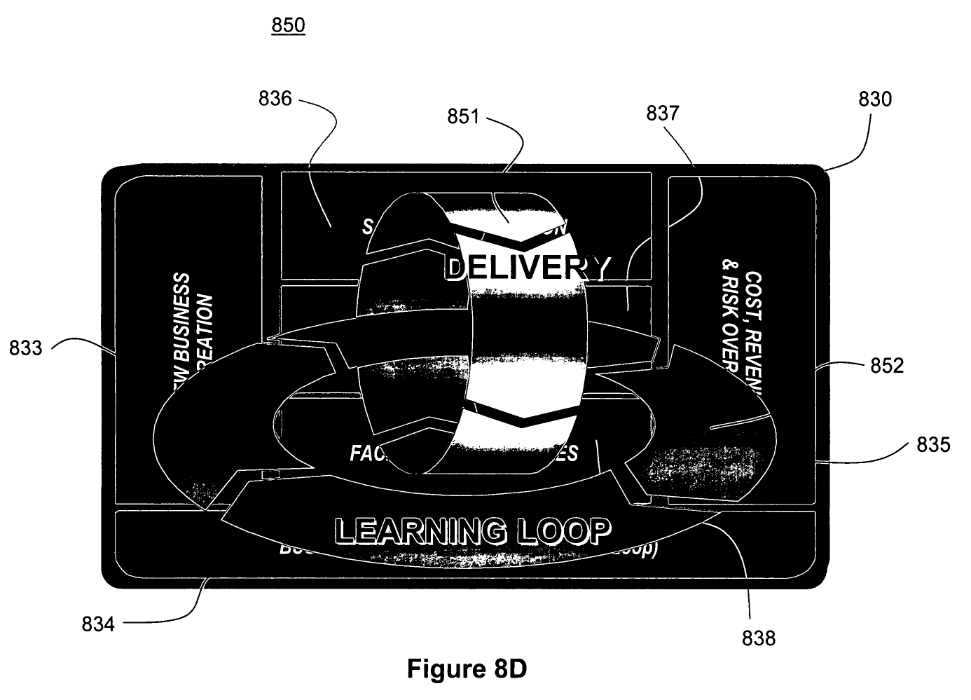

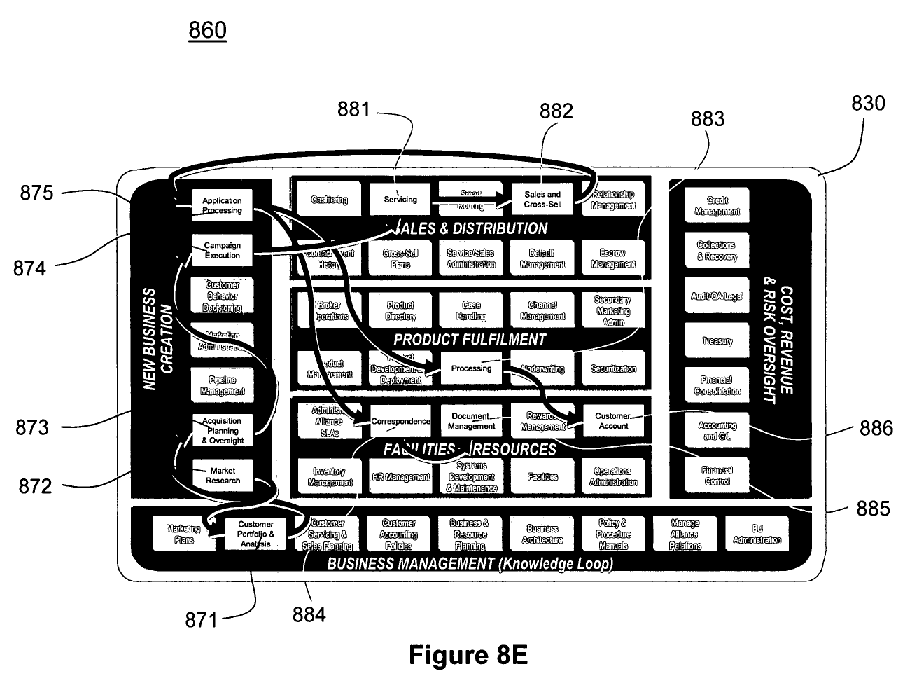

Another display structure helpful in identifying opportunities for improving performance of the business in the course of an alignment project is the dynamic map described in connection with FIGS. 8A through 8E. An exemplar target component map 810 is shown in FIG. 8A. Overlaid upon the map 810 is a “wiring diagram” connecting a number of components in a business transaction defined by a chain of service interactions between components connected as shown. The “market research” component 872 comes up with an insight that identifies certain kinds of customers as sales prospects. The “customer portfolio and analysis” component 871 asks which customers meet that identified criterion, and pass them to the “acquisition planning and oversight” component 873 who confirm that an effort should be made to sell to these customers. The process then goes to the “campaign execution” component 874, which makes contact to determine whether the identified customers are interested, and if so the potential customers are passed over to the “servicing” component 881 where they talk to them, where they say “yes” or “no”. If they say “yes” then they are passed on the “sales and cross sell” component 882 where they negotiate the deal. If the customer buys, the deal is passed to the “application processing” component 875, which invokes the “correspondence” component 884 to send them documents for signature, and when the signed documents are returned as legal documents they are handled by the “document management” component 885. At the same time the matter is sent to the “correspondence” component 884 it is also sent to the “processing” component 883 for handling the new product order and to the “customer account” component 886 for setting up the supporting customer account.

It will be noted that the “wiring diagram” for this process on the static component map 810 is a maze of spaghetti. The display is understandable, with effort, but does not provide any particular analytical clarity. However, these components on the static component map 810 of a business may be mapped 820 onto the categories of a dynamic map 830, as shown in FIG. 8B. There are six areas on the dynamic map 830, each reflecting logical groupings of components as shown in category map 820. There are three groupings forming a “U” shape around the perimeter of the dynamic map 830. There is an “insight” category of components that is transposed into the “new business creation” group 833, a “foresight” category that is transposed into the “business management” group 834, and an “oversight” category that is transposed into the “cost, revenue & risk oversight” group 835. Similarly, there are three groupings in the center of the “U” of the dynamic map 830. A “distribution” category of components is transposed to the “sales and distribution” group 836, a “manufacturing” category is transposed to a “product fulfillment” group 837, and an “operations” category is transposed to a “facilities & resources” group 838. Note that the mapping is complete, that is, that all the components in component map 810 are categorized 820 and mapped into one of the six groups on the CBM dynamic map 830, as shown in the display structure 840 of FIG. 8C.

The new business creation category 833 groups components that have a role in providing new customers, new products and new shared services, based on business focus and targets provided by the business management category 834. The business management category 834 groups components that generate business focus and targets for components in the business creation category 833 and provide resources to those components that produce and deliver products and services to the market place. Components that monitor needs and utilization of the delivery components or receive information about the risks and rewards of capital are also grouped in the business management category 834. The cost, revenue and risk oversight category 835 groups components that monitor risks and rewards associated with credit, product and operations of the delivery components.

The sales and distribution category 836 groups components that handle new customer insights generated by components in the new business creation category 833, and provide information on credit risk and reward to components in the cost, revenue and risk oversight category 835. Components that interact with the customer, or interact on the distribution side with components that are responsible for product fulfillment, are also grouped in the sales and distribution category 836. Components that provide product fulfillment are grouped in the product fulfillment category 837. Components that handle new product insights generated by components in the new business creation category 833, or provide information on product risk and reward to components in the cost, revenue and risk oversight category 835, are also grouped in the product fulfillment category 837. Components that handle new shared services insights generated by components in the new business creation category 833, or provide information on operations risk and reward to components in the cost, revenue and risk oversight category 835, are grouped in the facilities and resources category 838. This category also includes components that share services with other delivery components and provide needs and utilization information to components in the business management category 834.

A conceptual suggestion of the utility of the dynamic map 830 is shown by display structure 850 in FIG. 8D, showing the interaction between delivery loop 851 encompassing the dynamic map categories of distribution (sales and distribution 836), manufacturing (product fulfillment 837) and operations (facilities & resources 838), and learning loop 852 encompassing the insight (new business creation 833), foresight (business management 834) and oversight (cost, revenue & risk oversight 835) categories of the dynamic map. Just as the enterprise component map 110 is a display structure that provides a handle into the organization of components and how they are connected to one another as arranged by managing concept and management accountability level, so the dynamic map 830 is a display structure that provides insight into how the components function in the continuing dynamic of the business as it adapts to the changing environment of the market place.

Both the static component map 110 and the dynamic component map 830 are views of components extracted from information stored in the repository. The dynamic map 830 supports overlays providing insights addressing how alignment of the business may be targeted to improve the capability of the business to remain responsive in an on-demand environment. It therefore provides a display structure complementary to the display structure provided by the static component map 110.

An example of such an overlay on the dynamic map 830 is shown in FIG. 8E, using the same components highlighted in FIG. 8A as an overlay upon the static component map 110. While the process can be described in the same way as in FIG. 8A, the interactions between components—tangled spaghetti connections when viewed on the static component map 110—have a more orderly and understandable flow when viewed on the dynamic component map 830, which makes the dynamic map display useful.

In principle, the foregoing presentation tools for assisting the user of the invention in assessing the difference between the current state of a business and the target component map may be followed by implementation plans to align each and every component of the business. As a practical matter, resource and time constraints may limit the focus of the alignment effort to a subset of those components whose alignment will most contribute to the success of the business. The alignment process in accordance with the invention may be repeated as necessary and as resources and time allow.

While the invention has been described in terms of a single preferred embodiment, those skilled in the art will recognize that the invention can be practiced with modification within the spirit and scope of the appended claims.

1. A method for representing a business, comprising partitioning the business into non-overlapping components representing a target state of the business, each component being a group of cohesive business activities.

2. A method as in claim 1, further comprising a display structure incorporating a component map of said components, said display structure being for
assessing differences between the target state and a current state of the business, and
using said differences to align the business with said target state,
wherein the partitioning of the business into non-overlapping components further comprises:
partitioning the business into non-overlapping competencies, each competency being comprised of one or more managing concepts; and
arraying said components by management level within said competencies.

3. A method as in claim 2, wherein each component is linked to another component by a service provided by one component and relied upon by the other.

4. A method as in claim 3, further comprising:
storing in a repository business information organized around elements of the component map;
providing in said display structure mechanisms for navigating through the information in said repository.

5. A method as in claim 4, wherein
said display structure contains a display element, a context element and a viewpoint element, said viewpoint element selecting a level of a component business model stack, and said context element including a representation of said component business model stack, and
said navigation mechanisms include a grid shift mechanism and a clock face mechanism for structuring information displayed in said display element.

6. A method as in claim 2, further comprising building an enterprise component map of activities of all businesses, said enterprise component map being partitioned into non-overlapping managing concepts.

7. A method as in claim 3, wherein a collaborative network is formed by a plurality of components interconnected by said linkages.

8. A method as in claim 7, further comprising representing said collaborative network as an overlay upon the component map.

9. A method as in claim 7, further comprising:
mapping the components of said component map onto a dynamic component map; and
representing said collaborative network as an overlay upon the dynamic component map.

10. A method as in claim 8, further comprising identifying priority components for alignment with the target state of the business.

11. A method as in claim 10, wherein identifying priority components further comprises:
applying attribute values to components on the component map;
overlaying the component map with a representation of the attribute values; and
using the overlaid representation to identify components whose alignment with the component map will most improve the business.

12. A method as in claim 11, wherein said attribute values include an attribute value indicating the competitive level of the component.

13. A system for representing a business, comprising:
a component map of activities of the business, the components being arrayed by competency and by management level, each component being a group of cohesive business activities within a competency, each competency constituting a non-overlapping partition of said activities; and
a display structure incorporating the component map and being used for assessing differences between a target state and a current state of the business, said differences being used to align the business with said target state.

14. A system as in claim 13, further comprising an enterprise component map of activities of all businesses.

15. A system as in claim 14, wherein each competency is comprised of one or more managing concepts.

16. A system as in claim 13, wherein each component is linked to another component by a service provided by one component and relied upon by the other.

17. A system as in claim 16, wherein a collaborative network is formed by a plurality of components interconnected by said linkages.

18. A system as in claim 17, further comprising an overlay upon the component map, the overlay representing said collaborative network.

19. A system as in claim 18, further comprising means for assessing differences between the component map and a current state of the business.

20. A system as in claim 19, wherein said assessing means further comprises:
means for overlaying upon the component map an identification of current systems; and
means for identifying shortfalls from an examination of said overlay.

21. A system as in claim 20, wherein said shortfalls are from the group of gaps, overextensions, and duplications.

22. A system as in claim 18, further comprising means for identifying priority components for alignment with the target state of the business.

23. A computer implemented system for representing a business, comprising:
first computer code for building a component map of activities of the business, the components being arrayed by competency and by management level, each component being a group of cohesive business activities within a competency, each competency constituting a non-overlapping partition of said activities;
second computer code for assessing differences between the component map and a current state of the business, said second computer code being further comprised of:
third computer code for overlaying upon the component map an identification of current systems; and
fourth computer code for identifying shortfalls from an examination of said overlay.

24. A computer implemented system as in claim 23, further comprising sixth computer code for identifying priority components among those being different from a current state of the business.

25. A computer implemented system as in claim 24, wherein said sixth computer code for identifying priority components further comprises:
seventh computer code for applying attribute values to components on the component map;
eighth computer code for overlaying the component map with a representation of the attribute values; and
ninth computer code for using the overlayed representation to identify components whose alignment with the component map will most improve the business.

26. Implementing a service for representing a business, comprising the method of
building a component map of activities of the business, the components being arrayed by competency and by management level, each component being a group of cohesive business activities within a competency, each competency constituting a non-overlapping partition of said activities; and
incorporating said map into a display structure for
assessing differences between the target state and a current state of the business, and
using said differences to align the business with said target state.

27. A method implementing a service as in claim 26, further comprising:
storing in a repository business information organized around elements of the component map;
providing in said display structure mechanisms for navigating through the information in said repository.

28. A method implementing a service as in claim 27, wherein
said display structure contains a display element, a context element and a viewpoint element, said viewpoint element selecting a level of a component business model stack, and said context element including a representation of said component business model stack, and
said navigation mechanisms include a grid shift mechanism and a clock face mechanism for structuring information displayed in said display element.

29. A method implementing a service as in claim 26, further comprising building an enterprise component map of activities of all businesses.

30. A method implementing a service as in claim 29, wherein each competency is comprised of one or more managing concepts.

31. A method implementing a service as in claim 29, wherein each component is linked to another component by a service provided by one component and relied upon by the other.

32. A method implementing a service as in claim 31, wherein a collaborative network is formed by a plurality of components interconnected by said linkages.

33. A method implementing a service as in claim 32, further comprising representing said collaborative network as an overlay upon the component map.

34. A method implementing a service as in claim 33, further comprising assessing differences between the component map and a current state of the business.

35. A method implementing a service as in claim 34, wherein said assessing differences further comprises:
overlaying upon the component map an identification of current systems; and
identifying shortfalls from an examination of said overlay.

36. A method implementing a service as in claim 35, wherein said shortfalls are from the group of gaps, overextensions, and duplications.

37. A method implementing a service as in claim 33, further comprising identifying priority components among those being different from a current state of the business.

38. A method implementing a service as in claim 37, wherein identifying priority components further comprises:
applying attribute values to components on the component map;
overlaying the component map with a representation of the attribute values; and
using the overlaid representation to identify components whose alignment with the component map will most improve the business.

39. A method implementing a service as in claim 38, wherein said attribute values include an attribute value indicating the competitive level of the component.

40. A method implementing a service as in claim 38, wherein said attribute values include an attribute value indicating the competitive level of the component.
